(19) United States
(12) Patent Application Publication
(10) Pub. No.: US 2015/0019986 A1
(43) Pub. Date: Jan. 15, 2015

(54) APPARATUS, SYSTEM AND METHOD FOR A GRAPHIC USER INTERFACE FOR A MULTI-DIMENSIONAL NETWORKED CONTENT PLATFORM

(71) Applicant: CRACKPOT INC., LAS VEGAS, NV (US)

(72) Inventor: Stephen White, Las Vegas, NV (US)

(73) Assignee: CRACKPOT INC., LAS VEGAS, NV (US)

(21) Appl. No.: 14/178,388

(22) Filed: Feb. 12, 2014

Related U.S. Application Data
(60) Provisional application No. 61/930,448, filed on Jan. 22, 2014.
(60) Provisional application No. 61/903,180, filed on Nov. 12, 2013.
(60) Provisional application No. 61/845,005, filed on Jul. 11, 2013.

(51) Int. Cl. G06F 3/0482; G06F 3/0484; G06F 3/0481; H04L 29/06

(52) U.S. Cl. CPC G06F 3/0482; H04L 65/40; G06F 3/04842; G06F 3/04817
USPC 715/744; 715/836

(57) ABSTRACT

A computer-implemented platform apparatus, system, and method for creating an element having three dimensions and capable of providing content of at least one of a plurality of types on a face in each of the dimensions. The apparatus, system and method may include a non-transitory computer readable storage medium having encoded thereon non-transitory computer executable instructions which, when executed by at least one processor, provide, on at least one computing network, a graphical user interface (GUI) for the computer-implemented platform that: provides access to a plurality of content comprising a plurality of content types; allows for selection of content from the plurality of content for accessibility uniquely on each of the faces of the element; provides at least one of a time, type and location stamp in association with the selected content for each face; and allows for selection of access rules for third parties attempting to access the selected content.

### CROSS-REFERENCE TO RELATED APPLICATIONS

This application claims priority to U.S. Provisional Patent Application Ser. No. 61/930,448, filed Jan. 22, 2014, entitled “System and Methods for Delivery Information and a Platform for Same”, U.S. Provisional Patent Application Ser. No. 61/903,180, filed Nov. 12, 2013, entitled “Systems and Method for Mobile Social Network Interactions”, and U.S. Provisional Application Ser. No. 61/845,005, filed Jul. 11, 2013 entitled, “Engine, System and Method of Providing Interactive Content Delivery Management”, each of which are incorporated by reference herein in their entireties.

The present application is also related to U.S. patent application Ser. No. ______, entitled “Multi-Dimensional Content Platform for a Network”, U.S. patent application Ser. No. ______ entitled “System and Method for Creating a Unique Media and Information Management Platform”, and U.S. patent application Ser. No. ______ entitled “Computer-Implemented Virtual Object for Managing Digital Content”, which are all filed contemporaneously, the entireties of which are incorporated by reference herein.

### BACKGROUND OF THE INVENTION

1. Field of the Invention

Computer-implemented platforms, apparatuses, systems, and methods are disclosed for the providing of content, and, more particularly, disclosed is an apparatus, system and method for a graphical user interface for a multi-dimensional networked content platform.

2. Description of the Background

In the present environment, one's virtual presence is synonymous with an actual, physical presence. That is, a large portion of who a person is—the person's interests, likes, beliefs, and the like—may be presented to the world via social media.

However, currently available platforms suitable to provide content of interest, and accordingly suitable to show the world one's interests, beliefs, etc., operate independently of one another. That is, a professional face, and hence professionally-related content, may be presented to the world via LinkedIn, and an artistic face, that is, artistic content, may be presented to the world via Instagram.

As such, the number of current communications platforms is overwhelming, and it is impossible to share multiple facets of a person using known methods. For example, a student athlete's have taken to developing their own unique websites to try to attract colleges, in part because there is no single platform presently available for the student athlete to share game videos, express herself, share her scholarly pursuits, likes, interests, hobbies, social/virtual presence, and more with a prospective college recruiting for such an athlete.

Moreover, known means of content provision do not scale well, in large measure because such means provide only two-dimensional methodologies for providing content. Accordingly, in typical known embodiments, a viewer of content provided by a user must scroll, flip, or otherwise maneuver as between content provision screens or the like. This is exceedingly inconvenient, particularly in a mobile environment having limited screen size.

There is thus no currently available platform that is suitable to provide various types and substantially unlimited amounts of content, including audio, image, video, text, site, RSS feed, social media, e-magazine, and e-commerce, integration in an interactive, digital interface. Further, it would be preferable that such a platform provide a three dimensional content-providing platform, to thereby improve the efficiency of providing the content. Additionally, a graphical user interface to allow for the creation of the aspects associated with such a platform would be advantageous.

Thus, the need exists for an apparatus, system and method for a graphical user interface for a multi-dimensional networked content platform.

### SUMMARY OF THE INVENTION

The present invention is and includes a computer-implemented platform apparatus, system, and method for creating an element having three dimensions and capable of providing content of at least one of a plurality of types on a face in each of the dimensions. The apparatus, system and method may include a non-transitory computer readable storage medium having encoded thereon non-transitory computer executable instructions which, when executed by at least one processor, provide, on at least one computing network, a graphical user interface (GUI) for the computer-implemented platform that: provides access to a plurality of content comprising a plurality of content types; allows for selection of content from the plurality of content for accessibility uniquely on each of the faces of the element; provides at least one of a time, type and location stamp in association with the selected content for each face; and allows for selection of access rules for third parties attempting to access the selected content.

Thus, the present invention provides an apparatus, system and method for a graphical user interface for a multi-dimensional networked content platform.

### BRIEF DESCRIPTION OF THE FIGURES

The present invention will be described in conjunction with the incorporated figures, in which like numerals represent like elements, and in which:

FIG. 1 illustrates exemplary aspects of a cube in association with the present invention;

FIG. 2 illustrates exemplary aspects of a cube in association with the present invention;

FIG. 3 illustrates exemplary aspects of a computing environment in the present invention;

FIG. 4 illustrates exemplary aspects of a computing environment in the present invention; and

FIGS. 5-48 illustrate exemplary aspects of a graphical user interface according to the present invention.

### DETAILED DESCRIPTION OF THE INVENTION

It is to be understood that the figures and descriptions provided herein may have been simplified to illustrate elements that are relevant for a clear understanding of the present invention, while eliminating, for the purpose of clarity, other elements found in typical systems and methods in the prior art. Those of ordinary skill in the art may thus recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent art.

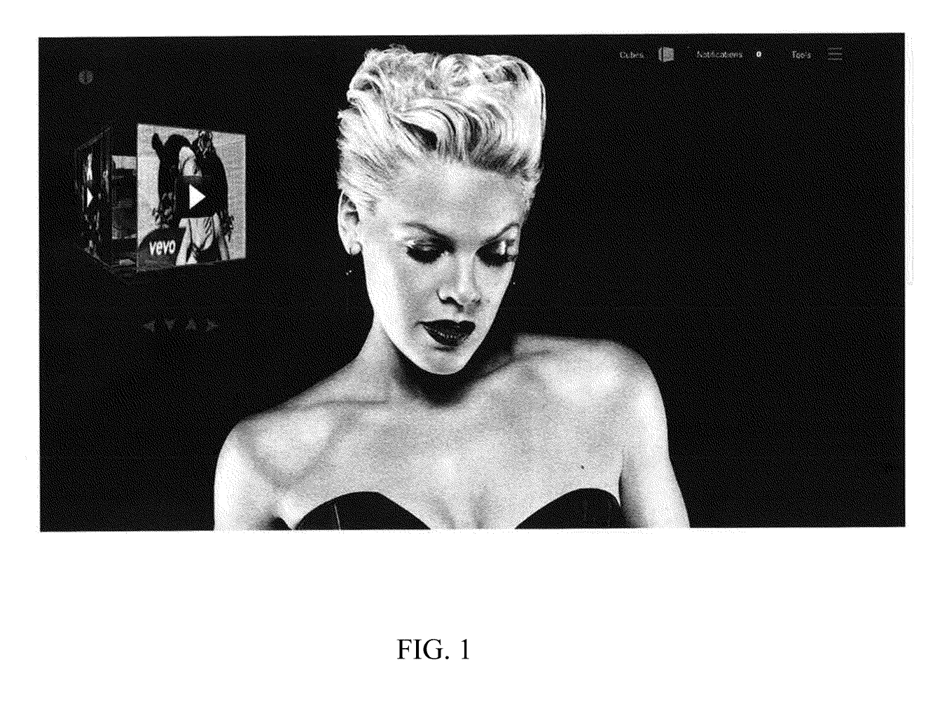

The present invention may provide for the simultaneous providing of myriad information, myriad content types, the limiting of information distribution, and improved relevancy of provided information, through the use of a “cube,” such as the cube illustrated in FIG. 1. Information and/or content posted to the cube may be given a time, type and/or location stamp, and may be accessible by at least one other user according to at least one set of rules.

The cube allows for an improved use of “on-screen real estate,” such as to allow improved user focus on a small screen, such as the screen of a mobile device. Particularly in a mobile environment, the user's at least one focus point may be on the cube as a whole (or the shape presented), for example, and the myriad of information/content available on the various faces thereof.

A user may have access to one cube or a plurality of cubes. For example, one or more cubes may be associated with a user account, and as such may be selected, designed, or otherwise provided by the user. That is, the user may select content and/or features for association with a cube, or, more particularly, with individual faces of the cube. Further, the user may have access to one or more cubes designed or otherwise provided by another. For example, one or more cubes associated with a third party, such as on a social network site, may be accessible to a fan, friend, associate, linked person, or the like.

Accordingly, the cube may also have at least one social network aspect and may allow for the aggregation and or presentation of one or more social networking channels. The accessing of an existing social network may provide the user with full and/or abbreviated access/presentation of the desired social network site, such as dependent on user rules. For example, access to a Facebook account may be limited to a portion of the Facebook information feed available and may thus be accessible on one side of a cube. In this way, for example, a user may limit the amount of viewed information to make more manageable the viewing of wanted versus unwanted information. For example, the user may block various side banner ads, picture streams and other disparate information feeds.

A cube may be comprised of a plurality, such as six (6), faces, and content and/or features may be provided on each face of the cube. Of course, the cube may have any number of faces, and the cube may have faces sized and shaped accordingly so as to accommodate a desired number of faces. By way of non-limiting example, a cube may be comprised of six (6) triangular faces joined at a single point at one point common to all of the plurality of triangular faces, and joined at a hexagonal face at the leg of each triangular face opposite the commonly-joined point.

The faces of the cube may be simultaneously viewable by a user, irrespective of which face(s) is (are) directly within view of the user. Additionally and alternatively, content associated with faces oblique to the user's direct view may be ghosted, transparent, opaque, underplayed (with the direct view face overlayed, and hence more significantly visible), represented iconographically (i.e., an arrow represents a video, a note represents music), or the like.

The user may preferably be enabled to graphically “rotate,” or otherwise “move,” the faces of the cube into direct view, such as using a finger, pointer, cursor, or the like. Such rotation may be limited (such as only in the x axis, or only in the y axis, or only in the x and y axes) or unlimited (such as free rotation through the x, y and z axes). The rotation may comprise an initial “grab” by the user, such as by a user indication using a mouse cursor, finger, or the like, followed by a user indication of movement. For example, the greater the extent of the user movement in a given direction, the greater the graphical rotation in that direction, and through the faces, which may occur. Alternatively, a user movement in a given direction may indicate a rotation only to the next available face following rotation in the indicated direction. Similarly, the extent of rotation in any given may be dictated by the speed of the user's indication in that direction—that is, a faster user movement may dictate a greater rotation. Likewise, a user may provide a movement or rotation indication using provided graphical user controls, such as directional on-screen arrows or the like.

The user may access the content indicated by a given face by accessing that face. For example, a particular face may be rotated into an at least partial view and, more preferably, into a direct view. Thereafter, the user may “release” the cube from the aforementioned “grab” and consequent rotation indication, and may indicate an access request. The access request may comprise a user indication to access the content associated with the accessed cube face.

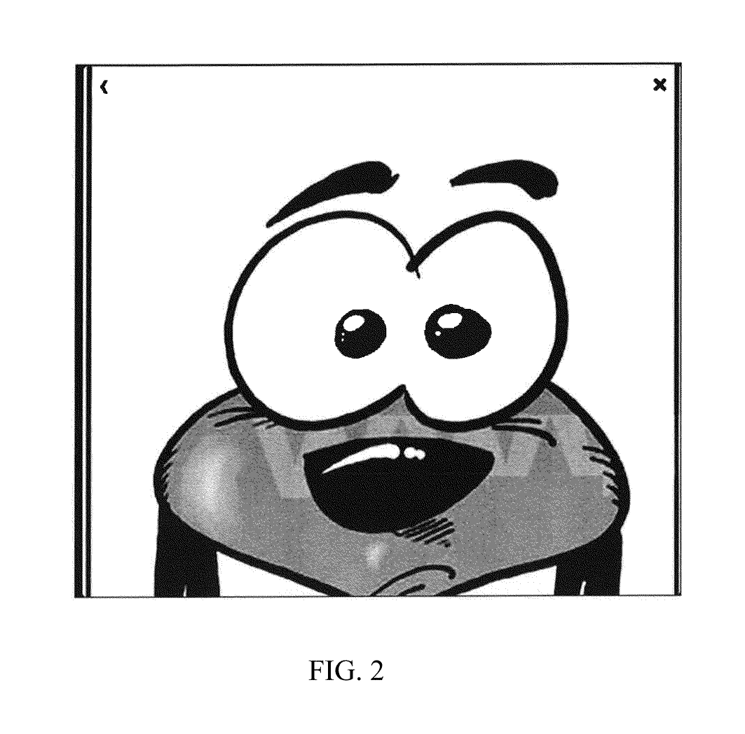

Content access may include, for example, the graphical providing of the accessed content in an exploded window, such as that shown in FIG. 2. In a preferred embodiment, the provided content at least partially includes the content indicated on the accessed face. Moreover, the type of content may be that indicated by the iconography associated with the accessed face.

In order to provide the accessed content, and the aforementioned graphical cube behavior, the cube may ping the user's device to identify the operating system being employed. Thereby, only the cube or cube features that are compatible with the identified operating system may be provided. Compatible cube code may be resident local to the user's interaction and/or may be provided remotely, and, irrespective of the location of the compatible cube code, the compatibility assessment may be made locally or remotely, and may be made upon first use of an identifiable device, or may be made upon each instantiation of cube access.

Once a compatibility assessment is made, the present invention may provide a platform for creating one or more cubes, such as via a thin client graphical user interface (“GUI”), i.e., wherein a user interaction in creating a cube occurs with a remote location, such as a Web site, or via a thick client GUI, i.e., using an application, or “app,” locally resident on a user device, and/or via a combination of thin and thick client interactions. In addition to allowing a user to provide content by cube creation, whether static and/or interactive, a user may also be enabled by a creation GUI to create content for inclusion on a cube.

In a non-limiting embodiment, the present invention may thus be implemented in one or more computing environments, using computing code, also referred to as software “code,” “engines,” “routines,” or the like. As such, computer-implemented platforms, apparatuses, systems, and methods are disclosed for providing an apparatus, system and method for a graphical user interface for a multi-dimensional networked content platform. This providing of content may occur with or without the downloading of an application (“app”), by way of example. As used herein, an app may preferably indicate an application on a mobile device, such as a smartphone, PDA, or a tablet computer, although, in certain embodiments an app may be partially or entirely included on a stationary device, such as a desktop or a laptop computer.

The described computer-implemented embodiments are intended to be exemplary and not limiting. As such, it is contemplated that the herein described systems and methods may be adapted to provide many types of users with access, delivery and/or reveal of many types of content, and can be extended to provide enhancements and/or additions to the exemplary content and/or content reveals described. The disclosed systems and methods are intended to encompass all such extensions, the protected scope of which are defined by the examples provided herein.

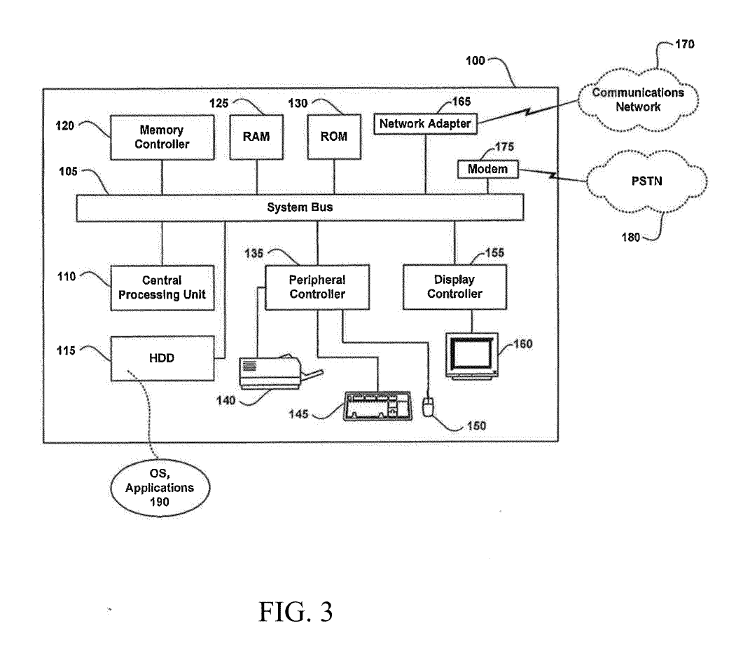

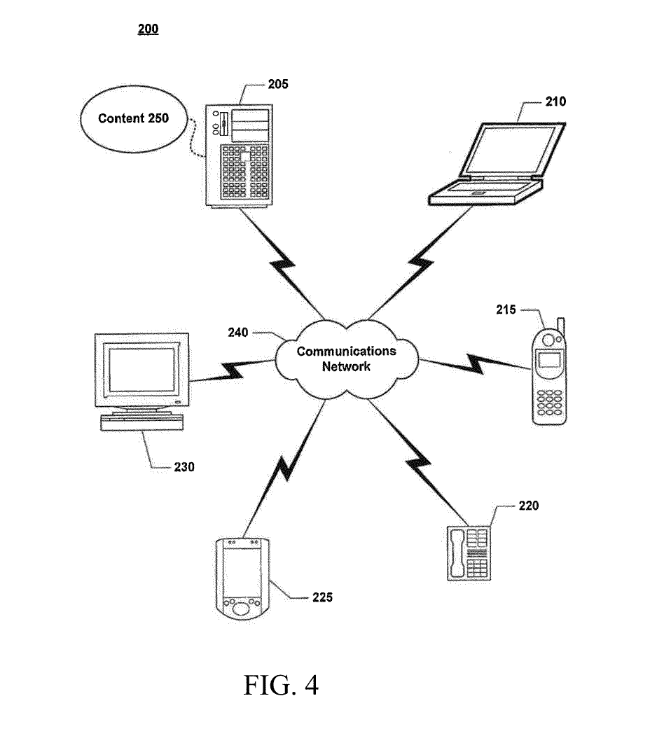

FIG. 3 depicts an exemplary computing system 100 that may be used in accordance with herein described apparatus, system and methods. Computing system 100 is capable of executing software, such as by providing an operating system (OS) and a variety of executable computing applications, or “apps,” 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel or touch display, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the data discussed herein. Communications network 170 may provide user access to computing system 100 with means of communicating and transferring software and information electronically, and may be coupled directly to computing system 100, or indirectly to computing system 100, such as via PSTN, WiFi, or cellular network 180. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations. That is to say, the inventive concepts described herein may be implemented in various computing environments using various components and configurations.

As shown in FIG. 2, computing system 100 may be deployed in networked computing environment 200. In general, the above description for computing system 100 applies to server, client, and peer computers deployed in a networked environment, for example, server 205, laptop computer 210, desktop computer 230, and various mobile computing devices 215. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone/smartphone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver and/or or communicate via applications specifically designed for mobile client devices, such as, for example, device 215. Client devices 215, 225 may be any mobile or stationary computer, computing device, telephone, PDA, tablet or smart phone and may have any device compatible operating system. Such operating systems may include, for example, Windows, Symbian, RIM Blackberry OS, Android, Apple iOS, Windows Phone, Palm webOS, Maemo, bada, MeeGo, Brew OS, and Linux. Although many mobile operating systems may be programmed in C++, some may be programmed in Java and .NET, for example. Some operating systems may or may not allow for the use of a proxy server and some may or may not have encryption. Of course, because many of the aforementioned operating systems are proprietary, in certain prior art embodiments server 205 delivers to client devices 215, 225 only those applications and that content applicable to the operating system and platform communication relevant to that client device 215, 225 type.

As discussed, cube creation may occur via a locally or remotely—interfaced GUI. The GUI may comprise a control panel, dashboard, widget, series of widgets, app, series of apps, or the like. Accordingly, although the present invention may be or include a microsite, more preferably the present invention comprises a platform which can house widgets and the like.

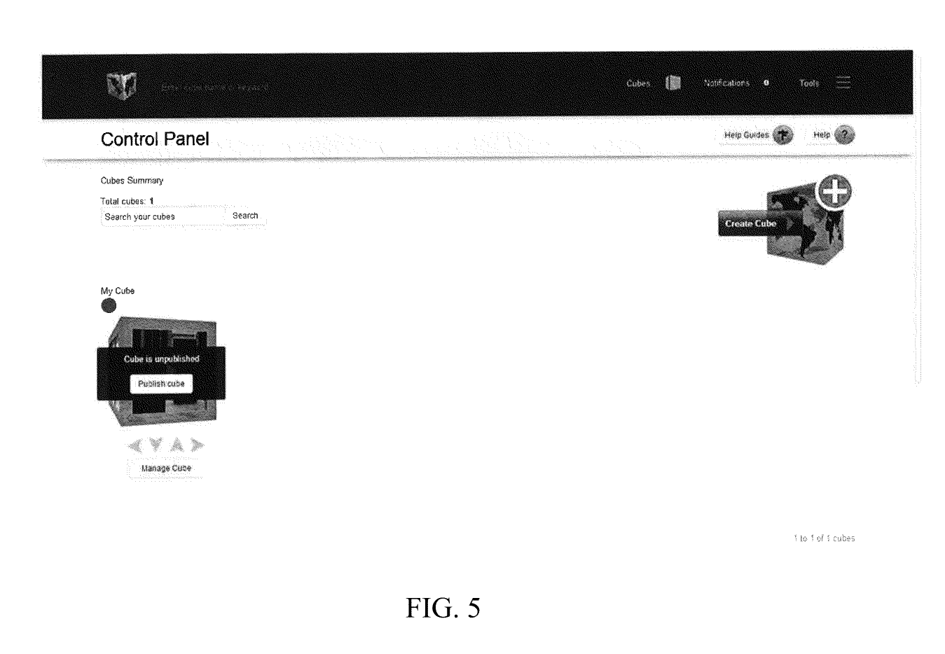

As referenced above, a user may request, or direct creation of, one or more cubes, wherein each cube may have one or more faces providing one or more content elements of any one of a variety of content types. FIG. 5 shows an illustrative control panel wherefrom a user may control creation and/or use/viewing of one or more cubes. As shown in FIG. 5, the user may have access from the control panel to create a new cube, search that user's library of cubes, or search externally stored or externally available cubes. Further, any cube selected for creation may be indicated as unpublished, such as during the time the user is preparing the cube, or published. Published cubes may be published to any one of a variety of selected publication locations, such as sites or the like. Further available at the control panel may be the user's login information, user notifications or messages, cube-related help, and user tools, by way of non-limiting example.

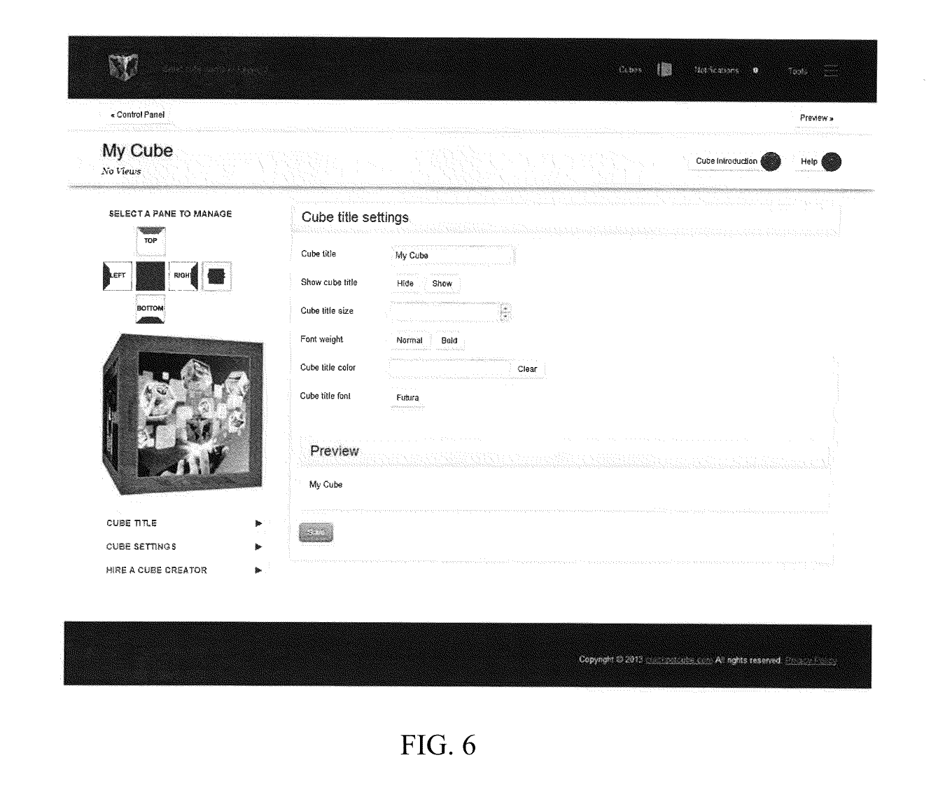

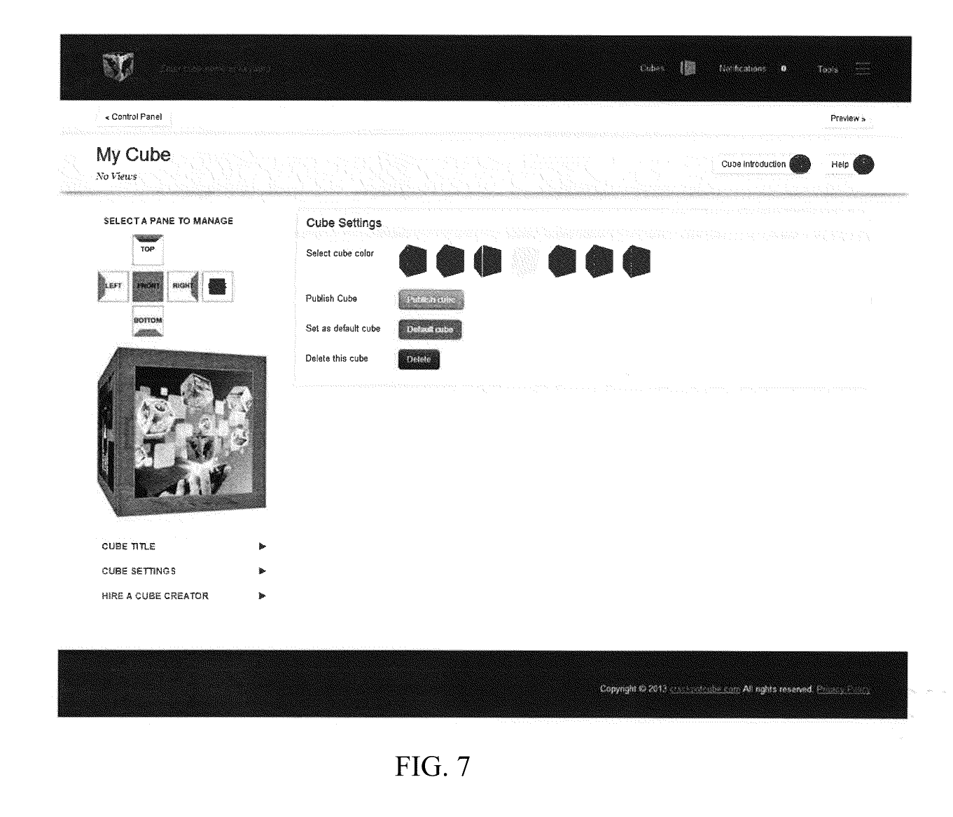

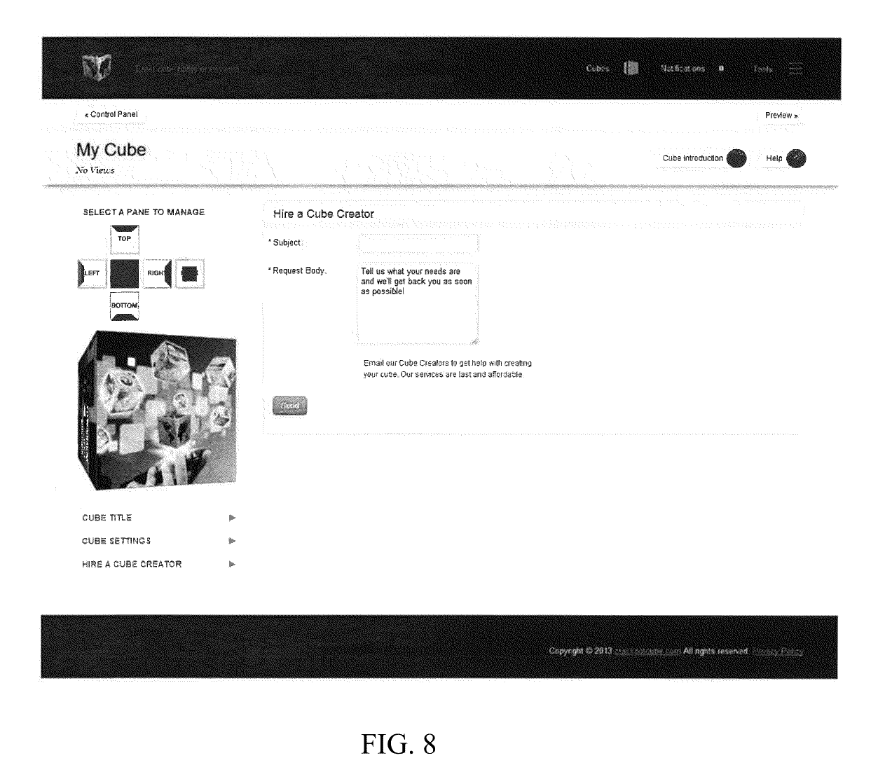

FIG. 6 illustrates an exemplary creation of a new cube. As illustrated, the cube size, cube name, cube font, cube color, cube number of panes or faces, and the like, may be selected from within the cube control panel. The selection of any of the variety of aspects of a cube under creation is further illustrated with respect to FIG. 7. Also illustrated in FIG. 7 is the availability of default settings for a cube, the ability to delete a cube, the ability to publish a cube to any of a variety of publication locations, and the ability to hire a cube creator. As is further illustrated with particularity in FIG. 8, the selection of a cube creator may be available from within the cube control area, and may include the ability to describe for a cube creator the user's requested features for the cube to be created.

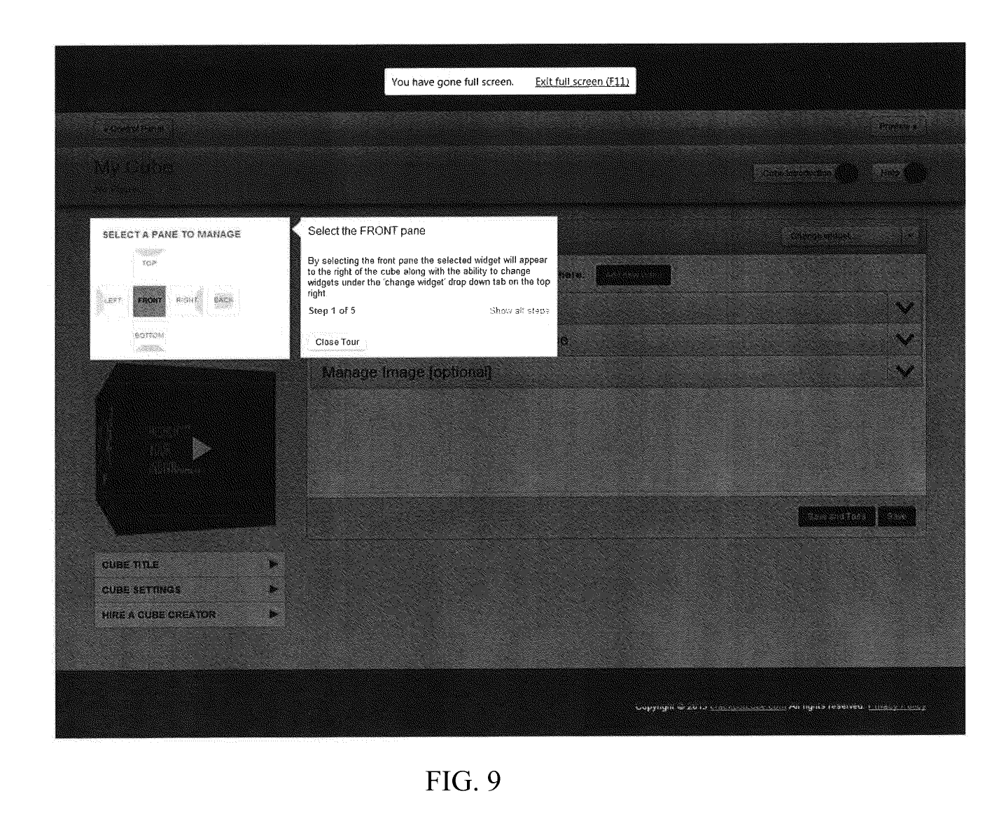

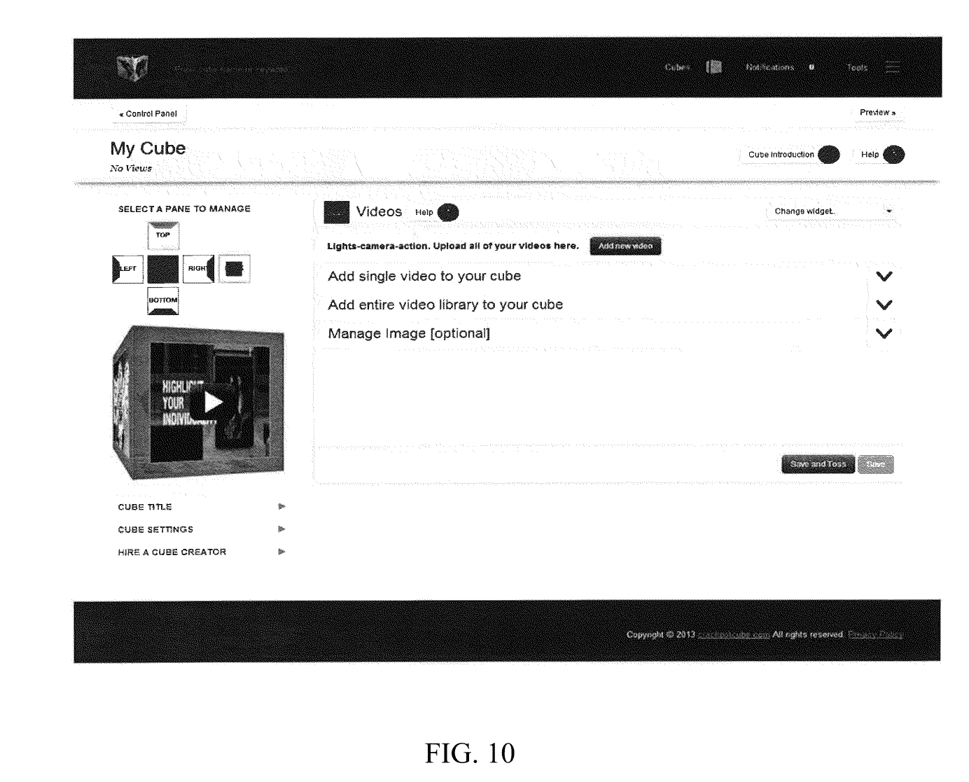

As referenced, and as further illustrated with respect to FIG. 9, each face of a created cube may have associated therewith particular content, and/or content of a particular type. FIG. 9 illustrates the exemplary selection of a particular face of a cube for association of content with that face of video content. Those skilled in the art will appreciate in light of the illustration of FIG. 9 that other faces and/or content and/or content types may be selected during cube creation. As is further illustrated with respect to FIG. 10, the creation of a video face may allow that the user may add a single video to the cube face, a video library to the cube face, and/or that the user may select an image or video snippet for association with the created video face.

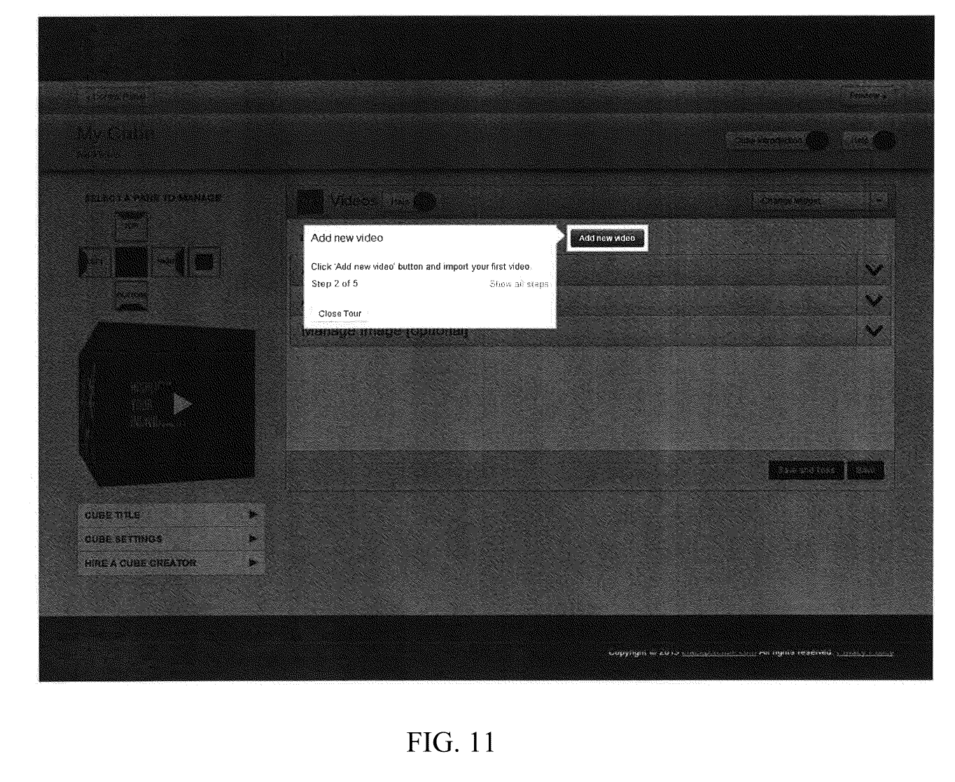

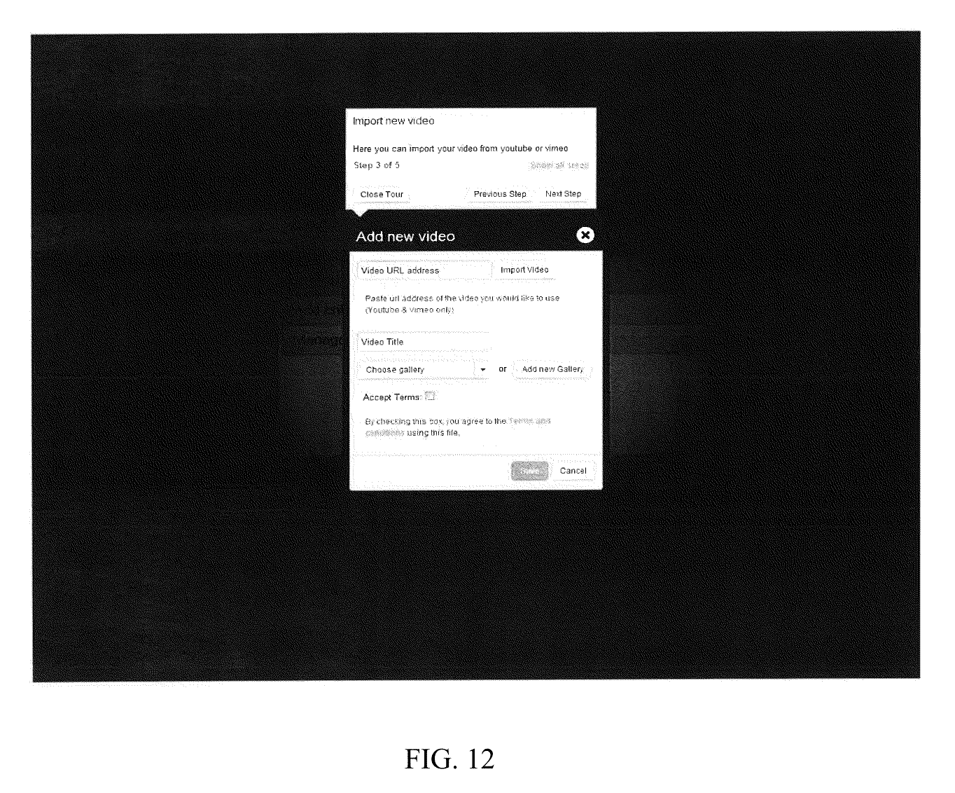

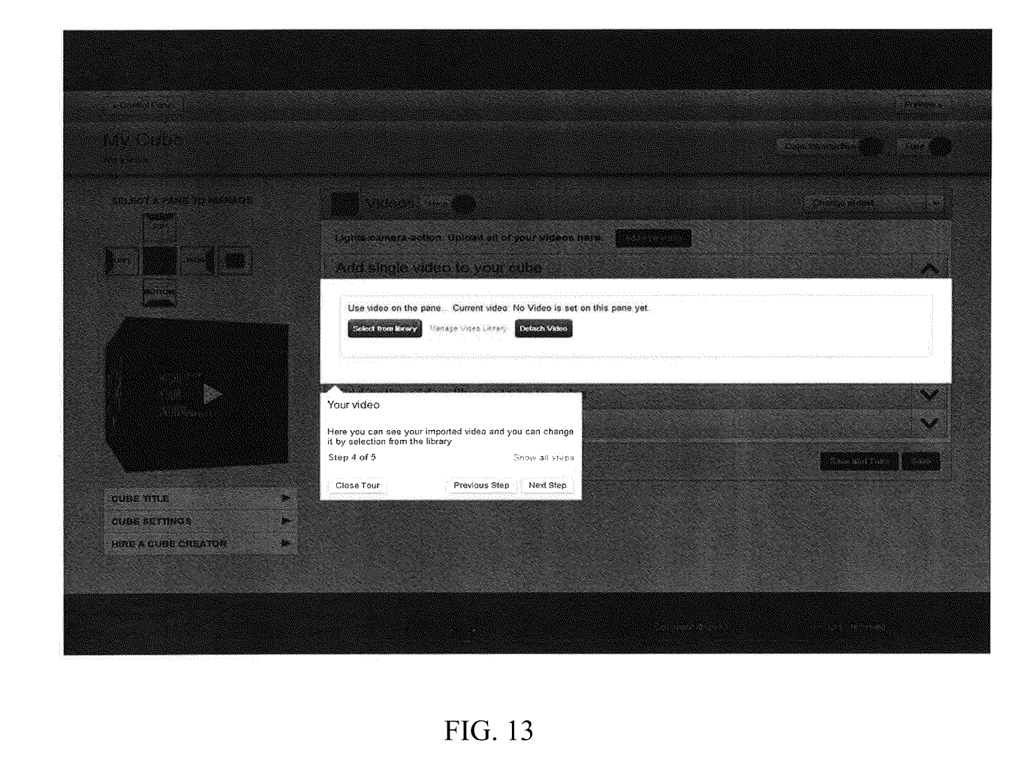

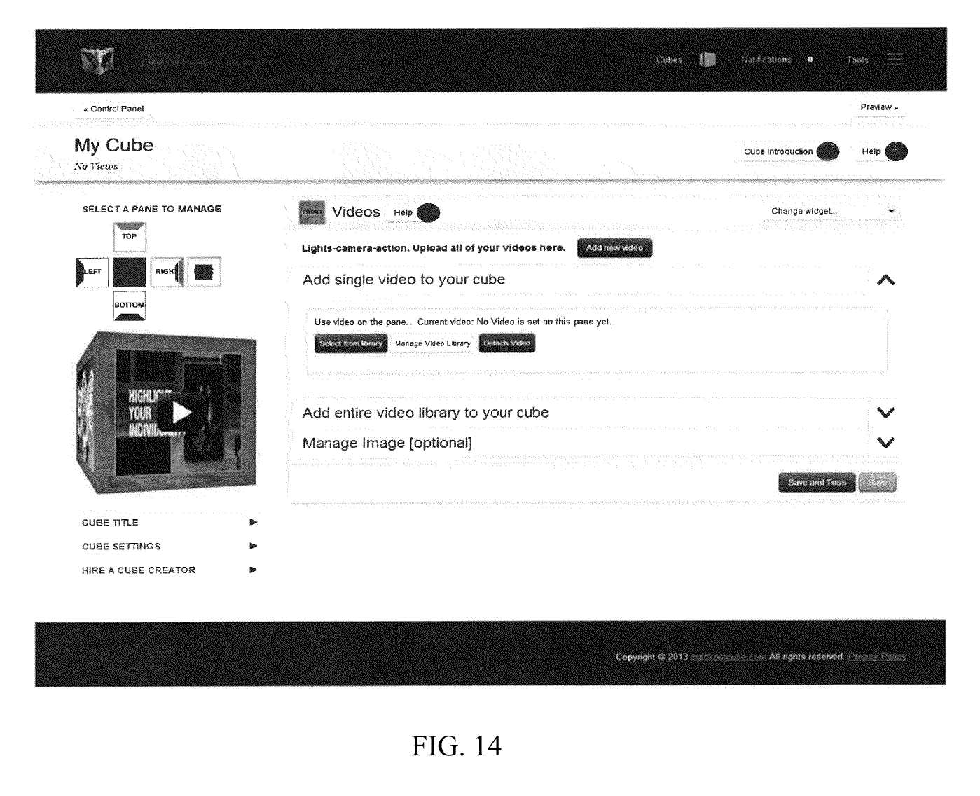

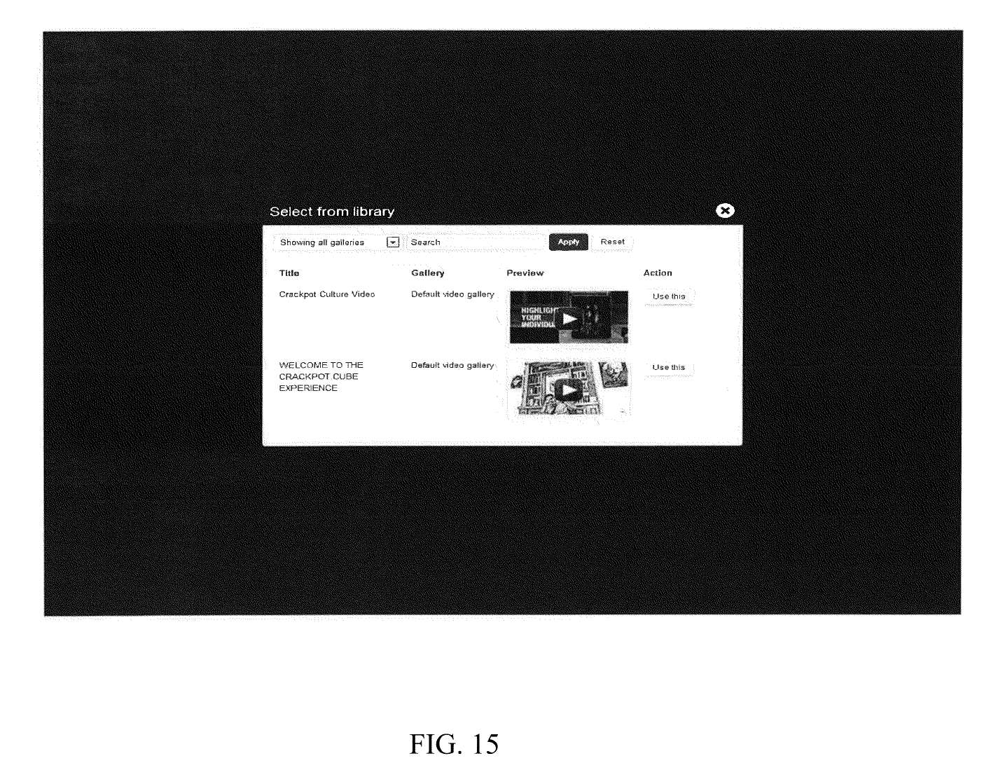

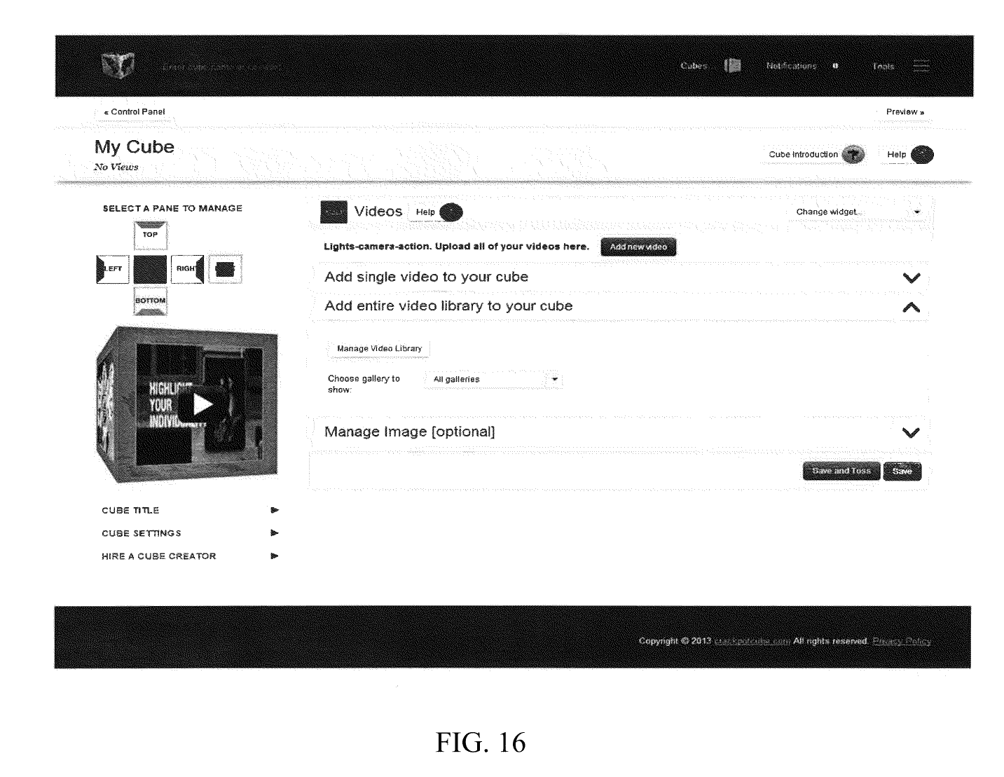

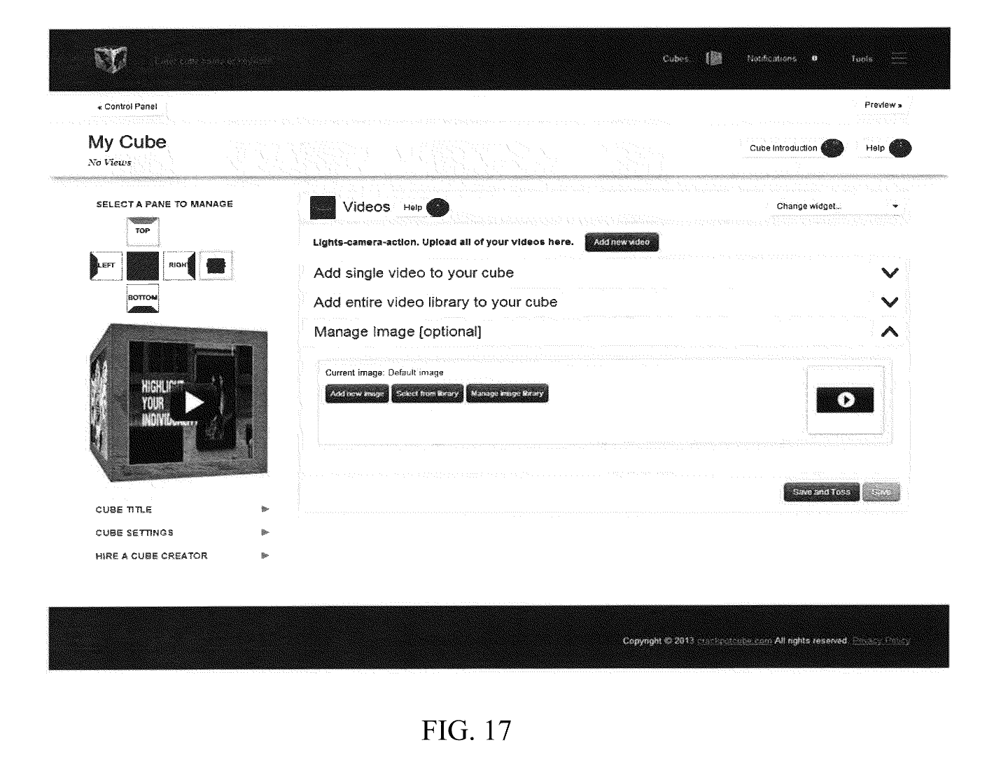

FIG. 11 illustrates that the user may select from within the cube control area to add a new video to the selected face. As illustrated in FIG. 12, the user may select a local or remote location (i.e., a site, server, database, memory location, or the like) from which the video to be associated with the face under creation is to be obtained. FIG. 13 is a further illustration of the capability to select video or a video library from local or remote locations for inclusion on a created cube video face. Moreover, FIG. 14 is an exemplary illustration of the selection of a single video for inclusion on the cube face. Such a single video, or multiple videos, may be selected from a user's video library that is associated with and/or otherwise available through the present GUI. The availability of videos from a user's video library is illustrated in the example of FIG. 15. The addition of an entire video library to a face of the cube, such as wherein the video library is selected from one or more available video libraries of the user, is illustrated in the example of FIG. 16. FIG. 17 illustrates the selection of an image or images to be associated with the created video face, and which may preferably be indicative of the video or videos associated with the created video cube face.

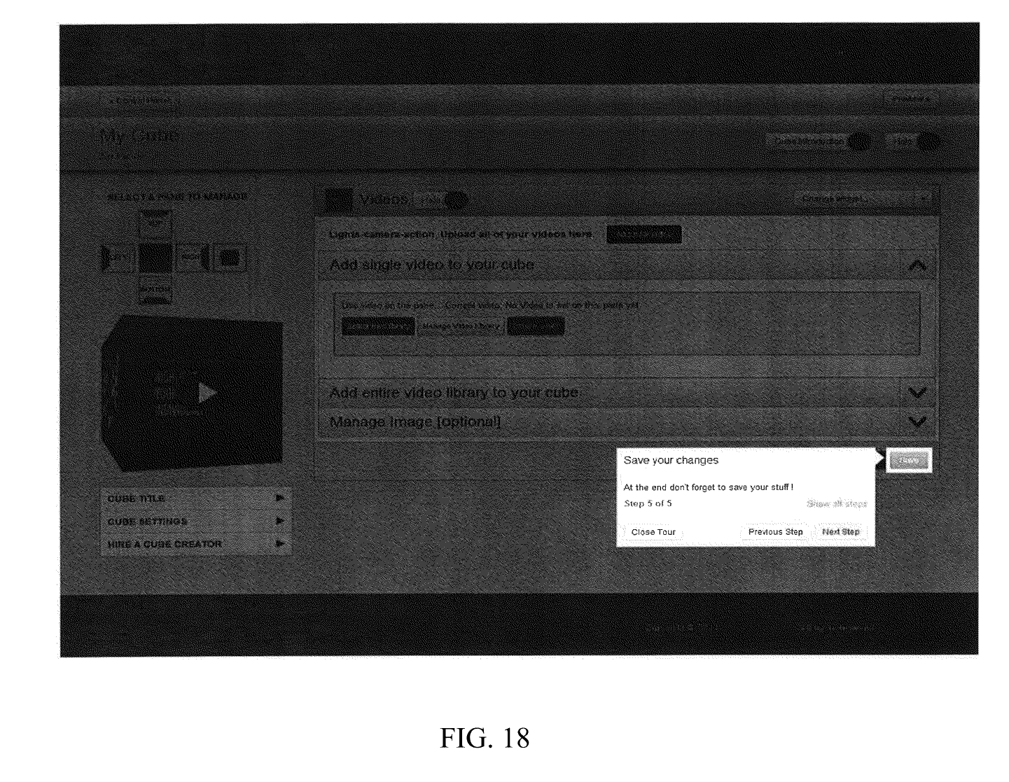

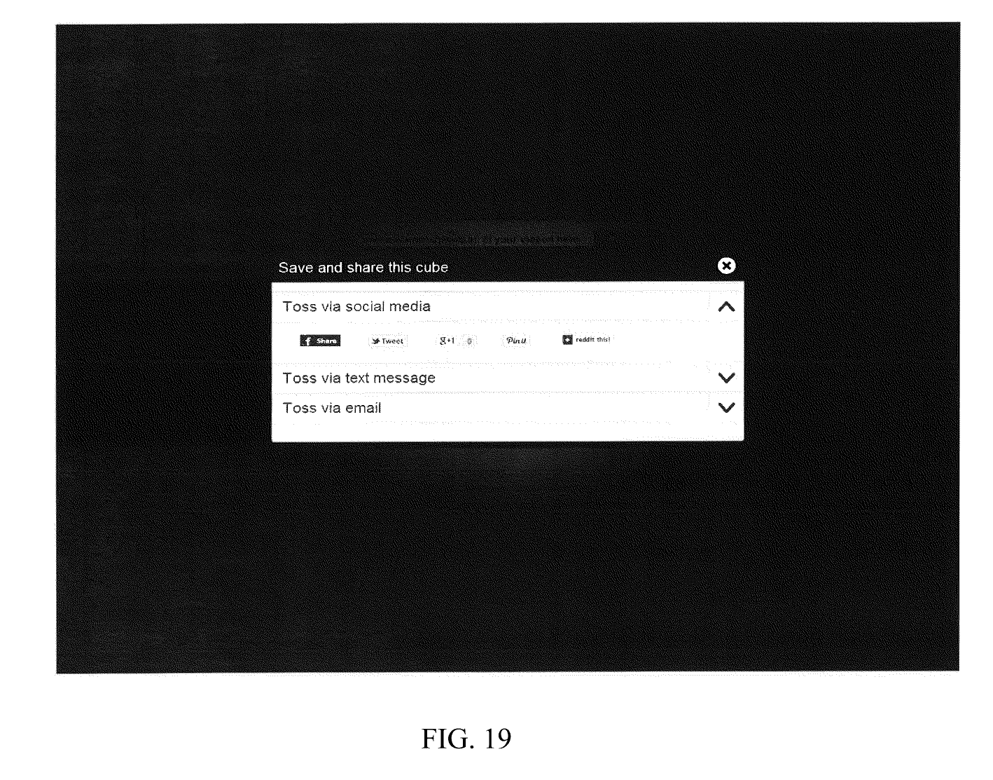

Finally, and as illustrated in FIG. 18, a single cube face, multiple cube faces, or a completed cube may be saved following creation by the user in the cube control area. Once saved, a cube having all faces filled, or a partial number of faces filled, may be published via any of a variety of methodologies, such as posting to social media, posting via text message, posting via email message, or the like. Such a publication is referred to as a “toss” in the exemplary embodiment of FIG. 19.

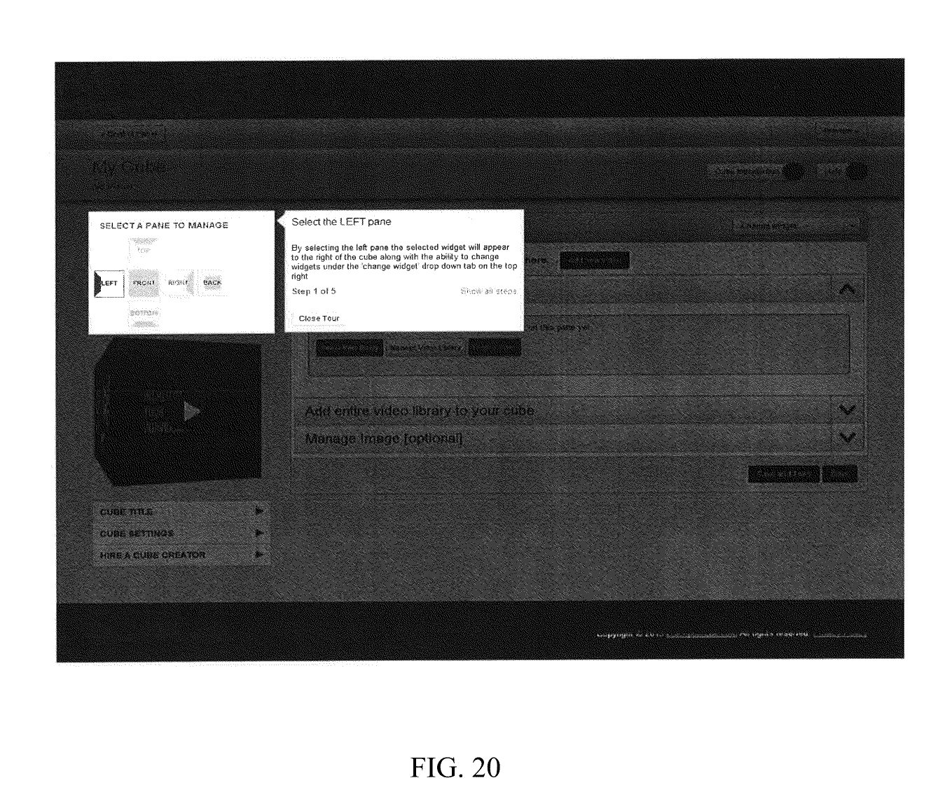

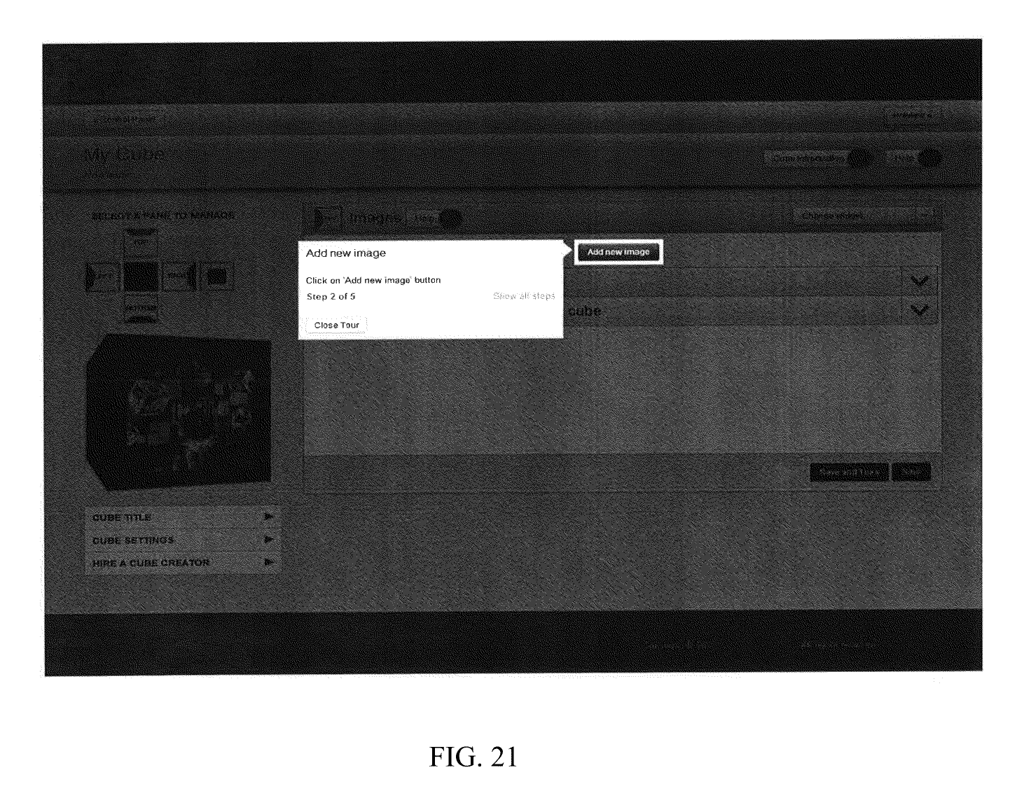

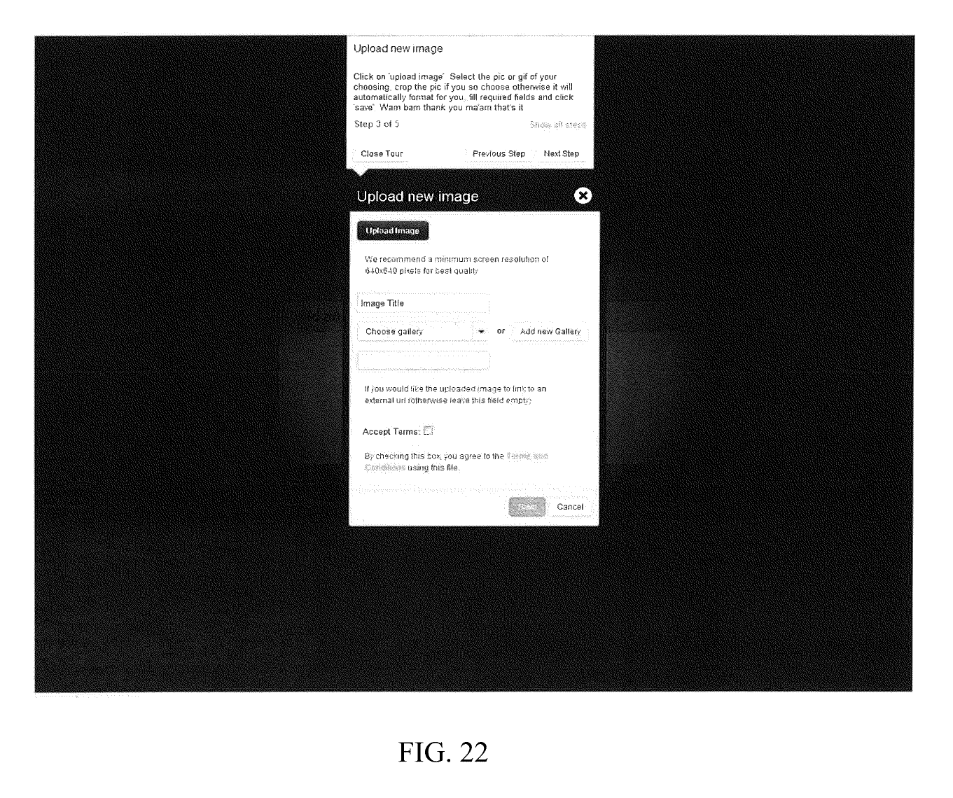

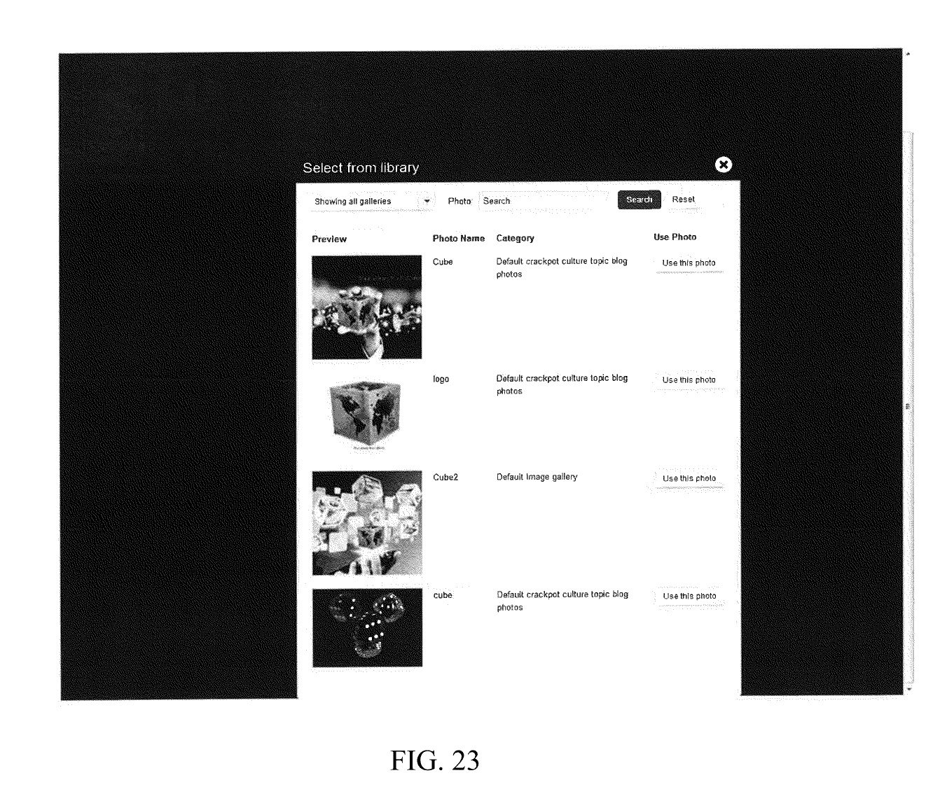

FIG. 20 illustrates the selection of a different face of a cube under creation for association with particular content. As illustrated in FIG. 21, the content of the illustrated cube face in this example is one or more images. As shown in FIG. 21, the creation of an image cube face may begin with the user's selection to add a new image and/or a new image cube face. FIG. 22 shows, in an exemplary embodiment, that the creation of an image cube face may include the uploading of a new image. The image for upload may be selected from a local or remote location, and from a user's image library or a third party image library, by way of non-limiting example. FIG. 23 is an exemplary illustration of the selection of an image by the user from such an image library. As shown, the images may be available to the user in one or more libraries, certain of which libraries may be available to all users of the cube generation software GUI, and certain of which libraries may be personal to the user, such as via log-in to the user's account within the cube system associated with the GUI.

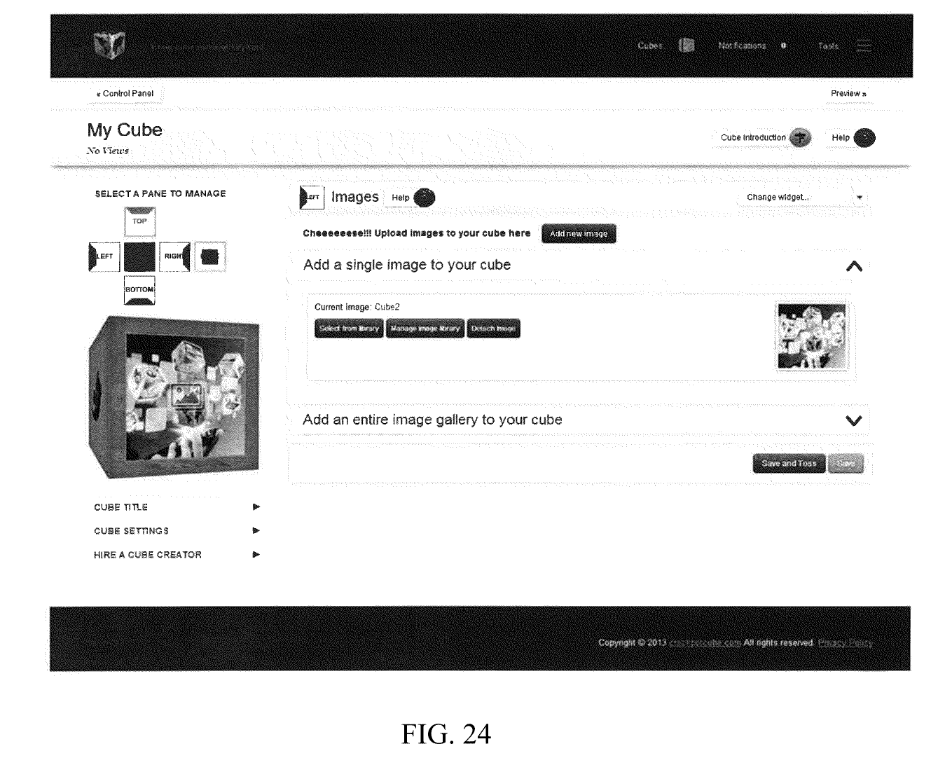

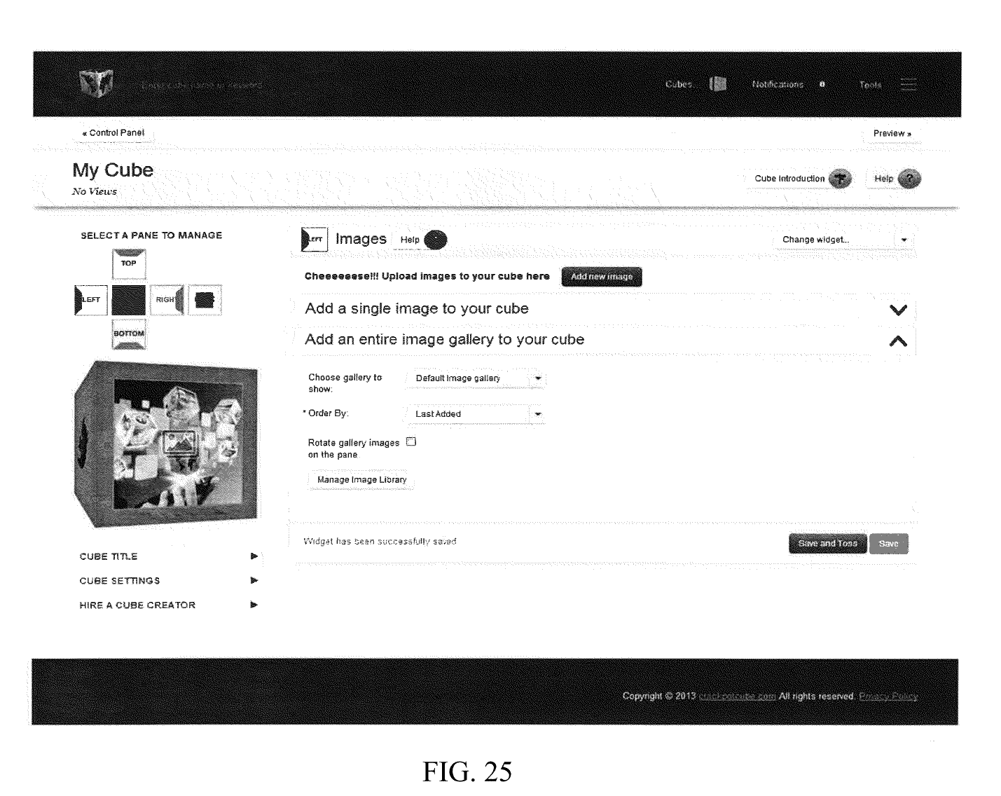

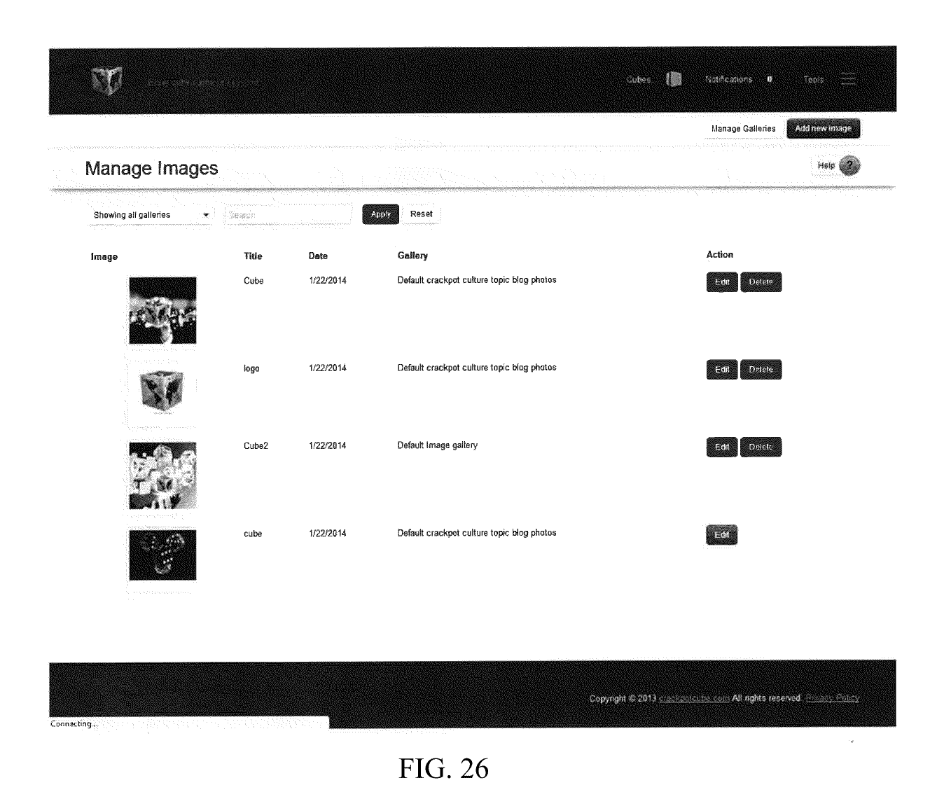

FIG. 24 shows, with greater particularity, the user's ability to select to add a single image to a cube face. Further, FIG. 24 illustrates that the image may be selected from one or more available libraries, and that image libraries may be managed from the cube control area. Further, it is evident from FIG. 24 that the cube name, and cube face, under creation by the user are preferably clearly illustrated to the user in the cube control area during creation of one or more new cube faces. FIG. 25 illustrates that an image gallery, or library, may be added to a cube face, and FIG. 26 illustrates that such an image library may be managed from the cube control area. Finally, a cube having an image face may be published, deleted, or modified, as discussed above.

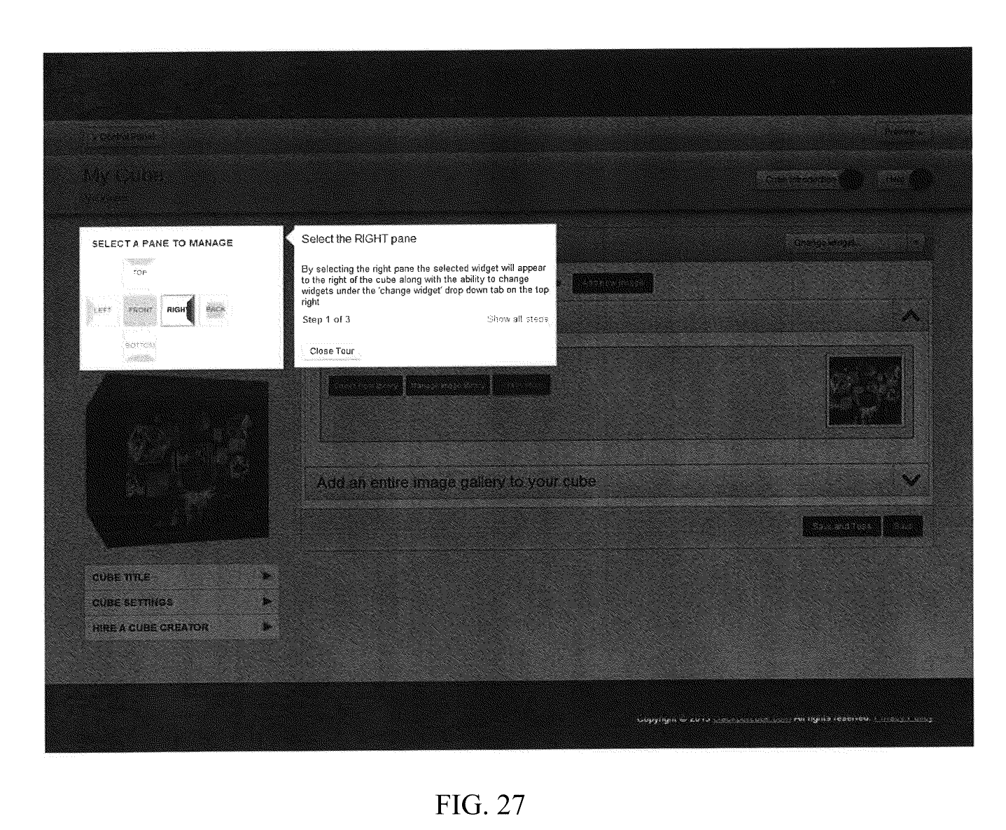

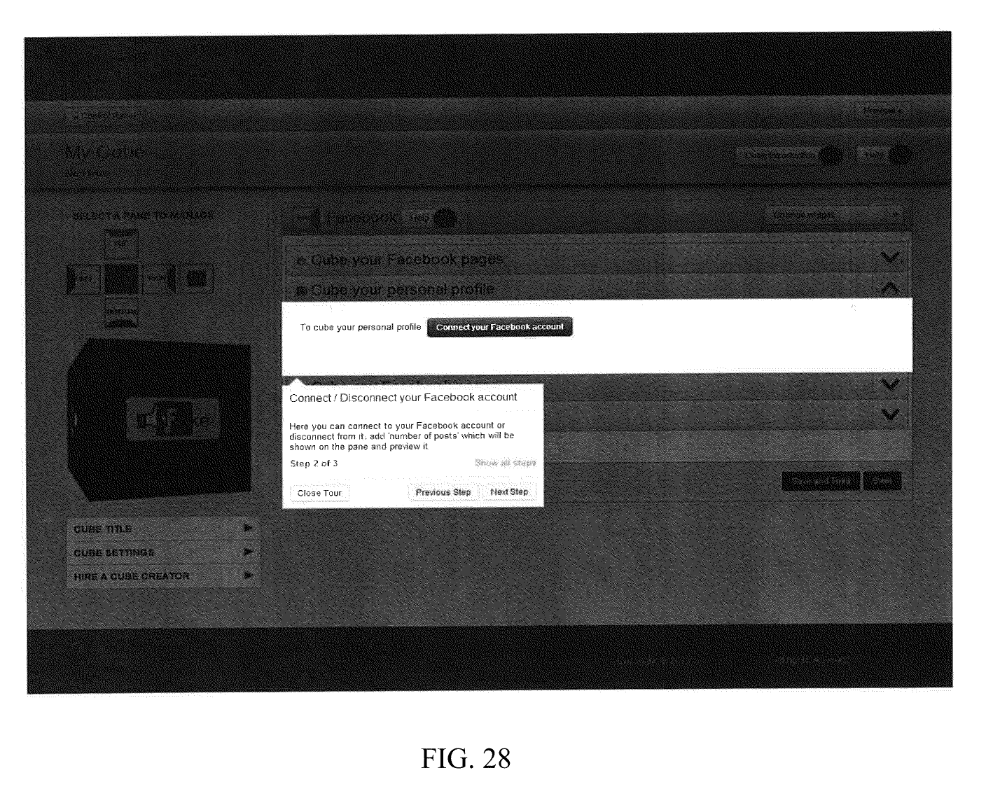

FIG. 27 illustrates the selection of a different cube face for association with that different cube face of a different cube content. As illustrated in FIG. 28, the content for this particular exemplary cube face is from a social media site, which is, in this instance, Facebook. In such a case, and as illustrated in FIG. 28, the user may be asked to connect his or her Facebook account to allow for accessing of content in that account for association with the created cube face.

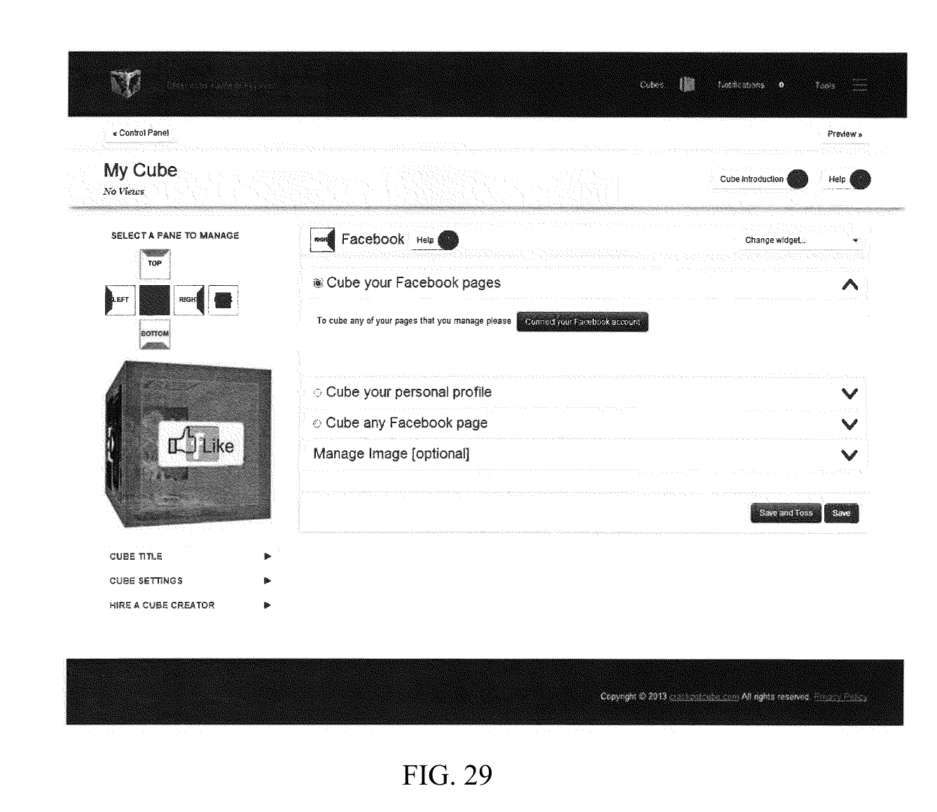

FIG. 29 is a further illustration that a user may associate his or her Facebook page(s) with a created cube face or faces. Also evident in FIG. 29, and as may be the case with all created cube faces, an iconography may be associated with the content type provided on each cube face. This iconography may preferably be indicative of the underlying content type available on the relevant cube face. As such, and as illustrated in FIG. 29, a Facebook-related icon may be associated with the Facebook-related content being “cubed” on the Facebook content face under creation in FIG. 29.

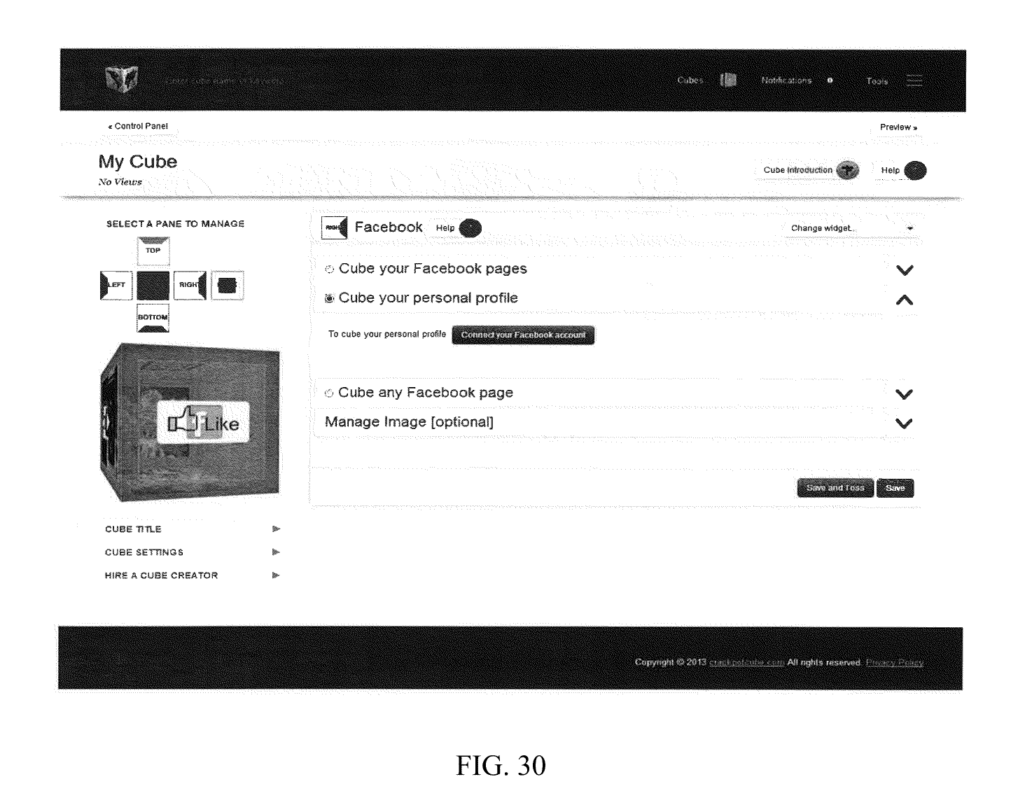

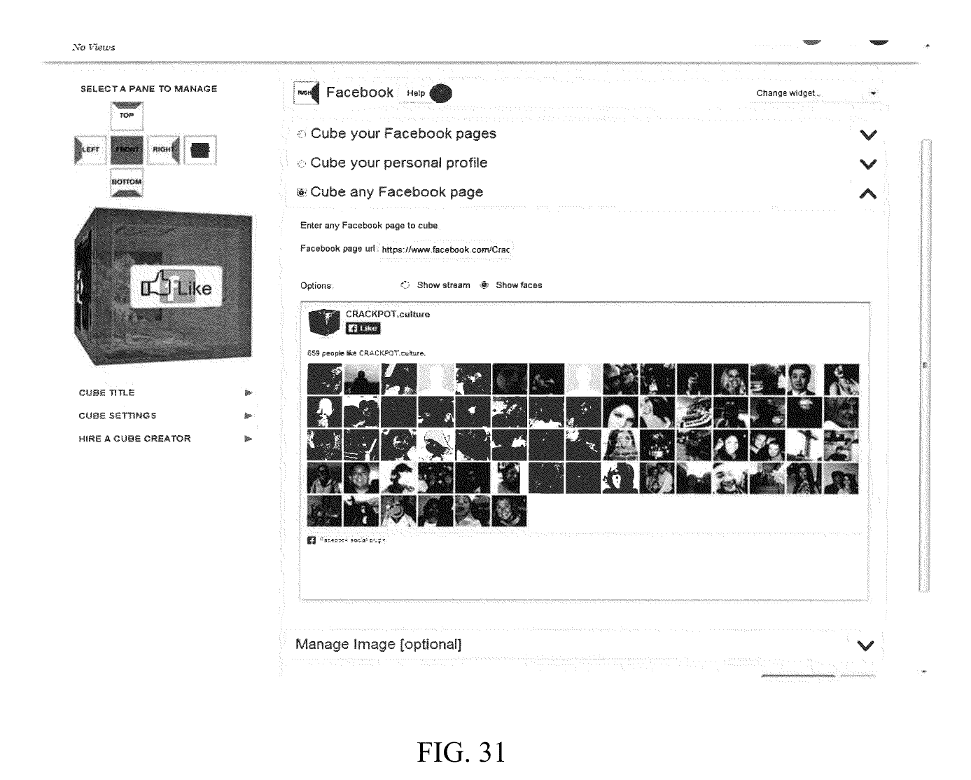

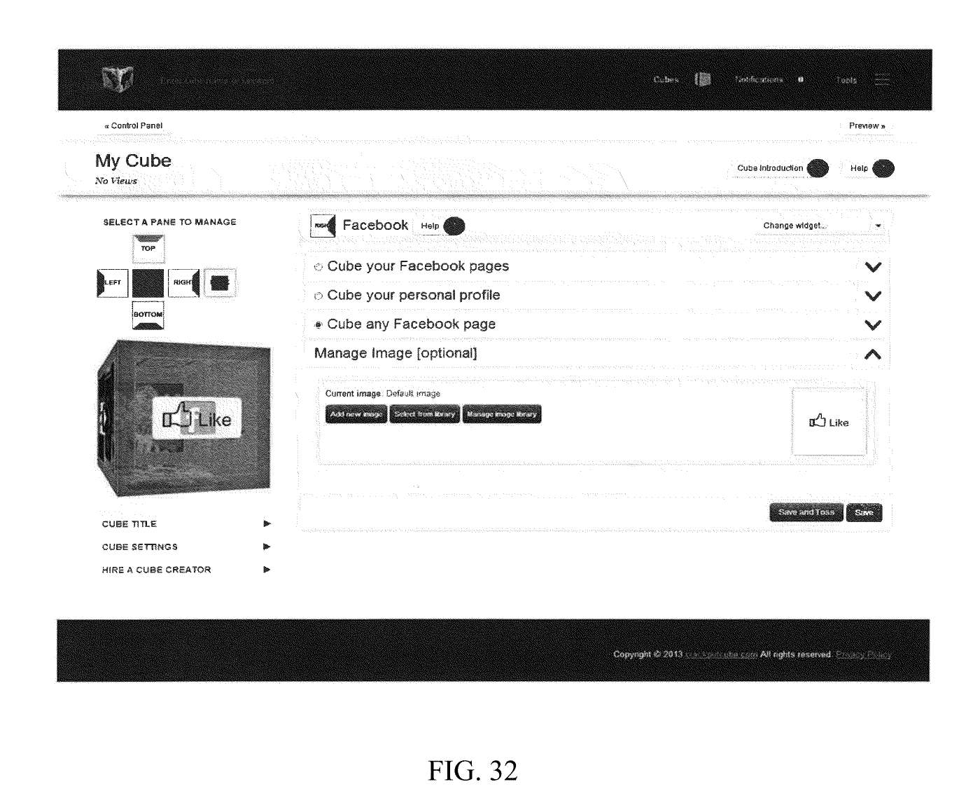

Moreover, and as illustrated in FIG. 30, a user's personal profile information, such as may be associated not only with the user's GUI account, but also with a social media site, may comprise the content associated with a created cube face. Additionally, and as illustrated in FIG. 31, external social media information not under the ownership or control of the user, such as the Facebook pages of others, may comprise the content associated with a created cube face. Of course, the use of such content may be subject to various permissions and/or authorizations, as will be understood to those skilled in the art. Finally, and as illustrated in FIG. 32, the user may select an image indicative of the underlying social media content for placement on the created cube face. In the illustrative embodiments herein, the referenced iconography may be “ghosted” over the selected indicative image on a given cube face, although those skilled in the art will appreciate in light of the discussion herein that the content type iconography may serve as the dominant aspect of a cube face, with the selected content-indicative image being “ghosted” under the icon for the content type.

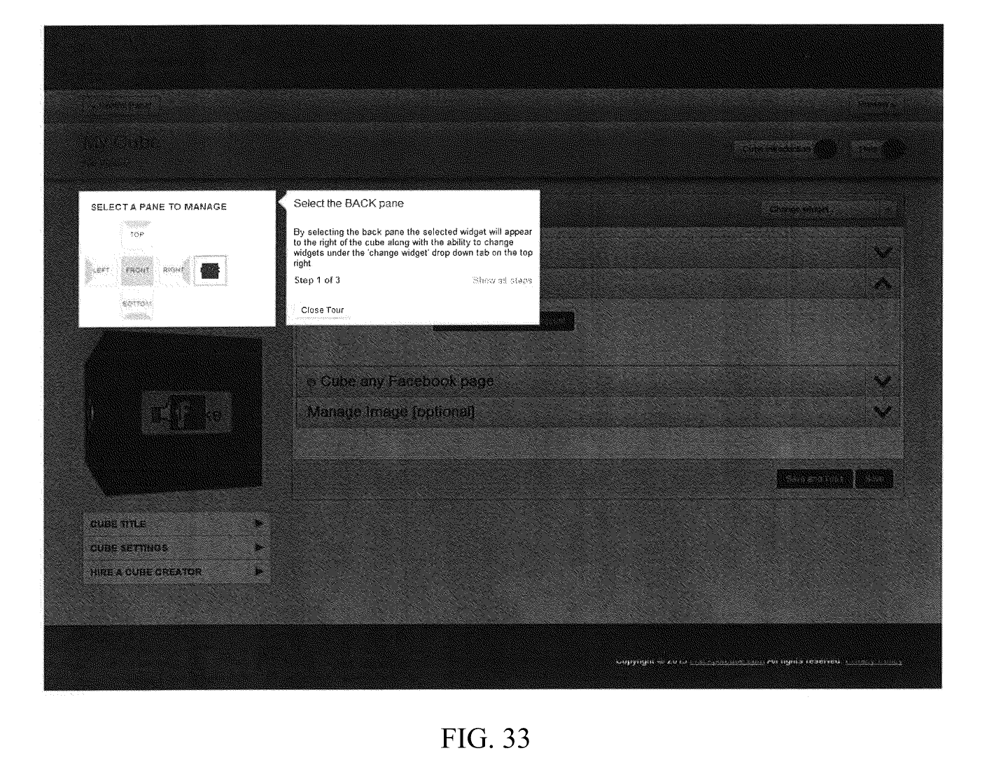

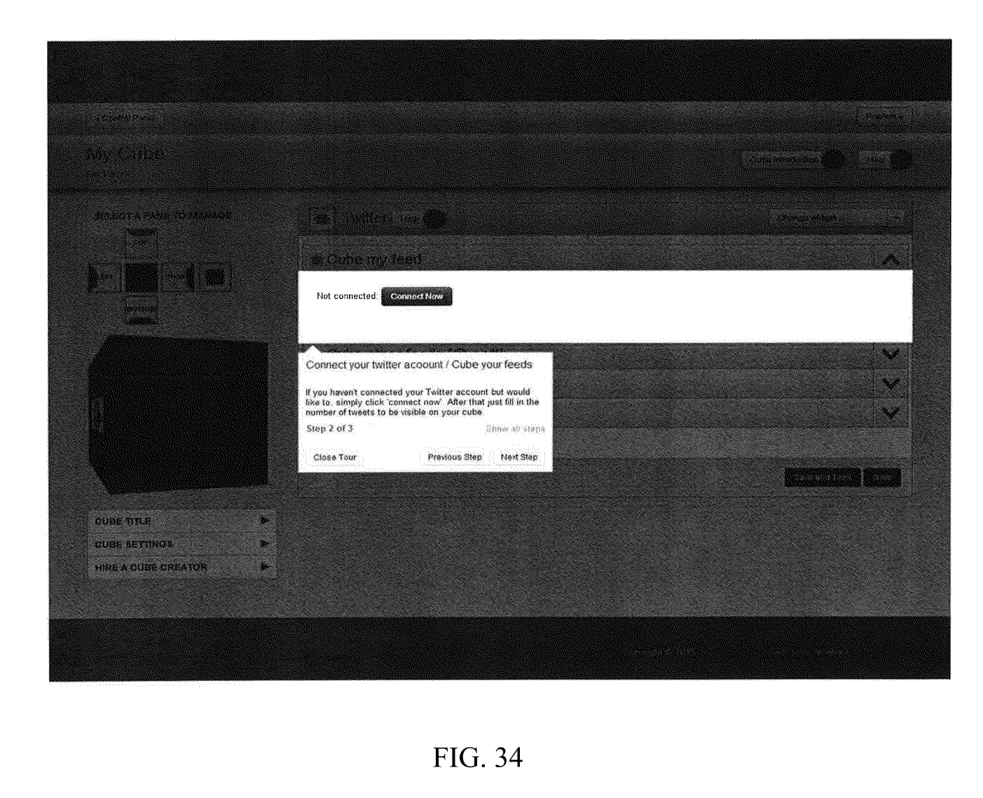

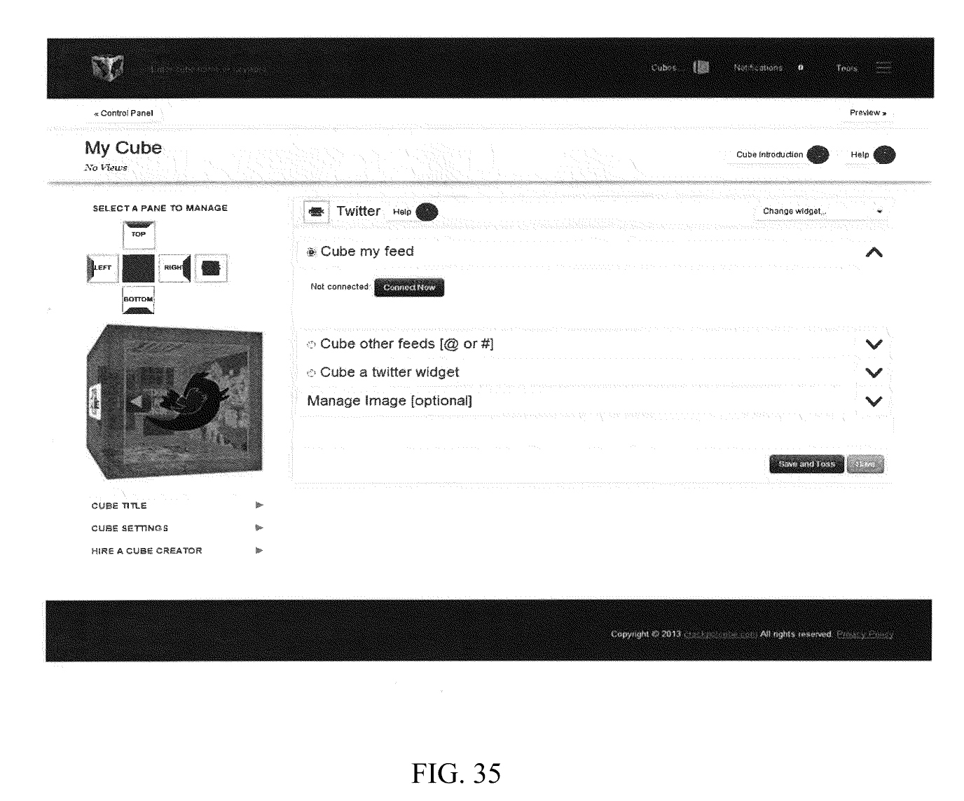

FIG. 33 is an exemplary illustration of the selection of another face of a cube under creation for content association. In this example, and as further illustrated in FIG. 34, the selected content type for association with the cube face under creation is again a social media site, and is, more particularly, Twitter in this example. As shown in FIG. 35, the user may select, by way of non-limiting example, to associate the user's Twitter feed with a cube face. Likewise, the user may associate Twitter feeds other than that/those of the user with a created cube face, and/or may associate a Twitter widget with a created cube face. Additionally, and as referenced above, the user may select an image indicative of the content associated with the created cube face, and an iconography indicative of the content type of the cube face under creation may be associated therewith.

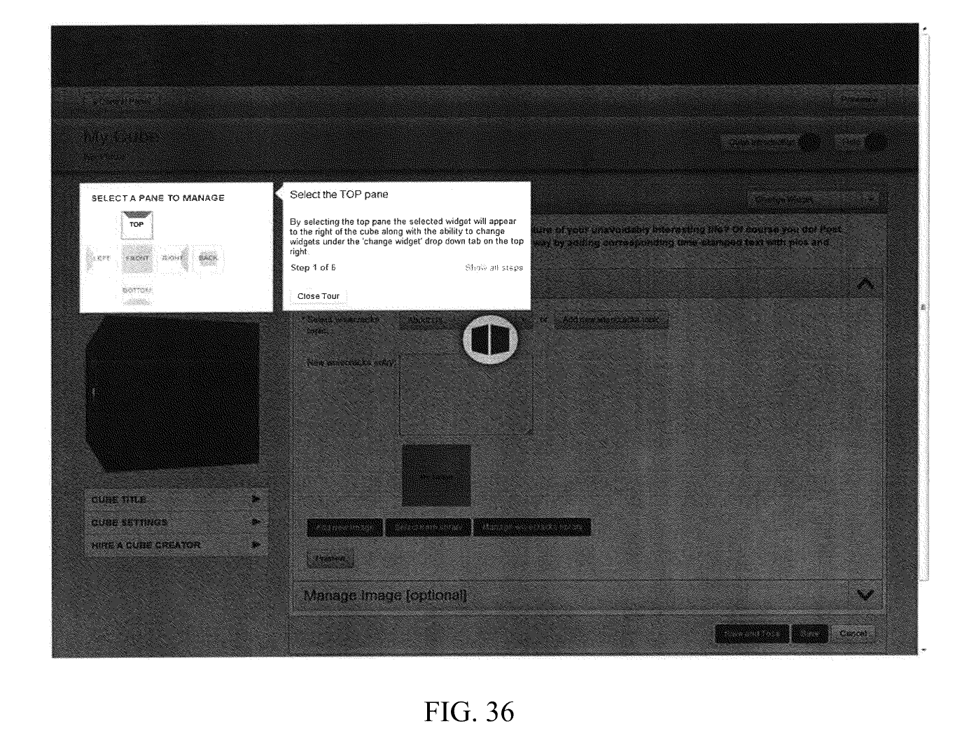

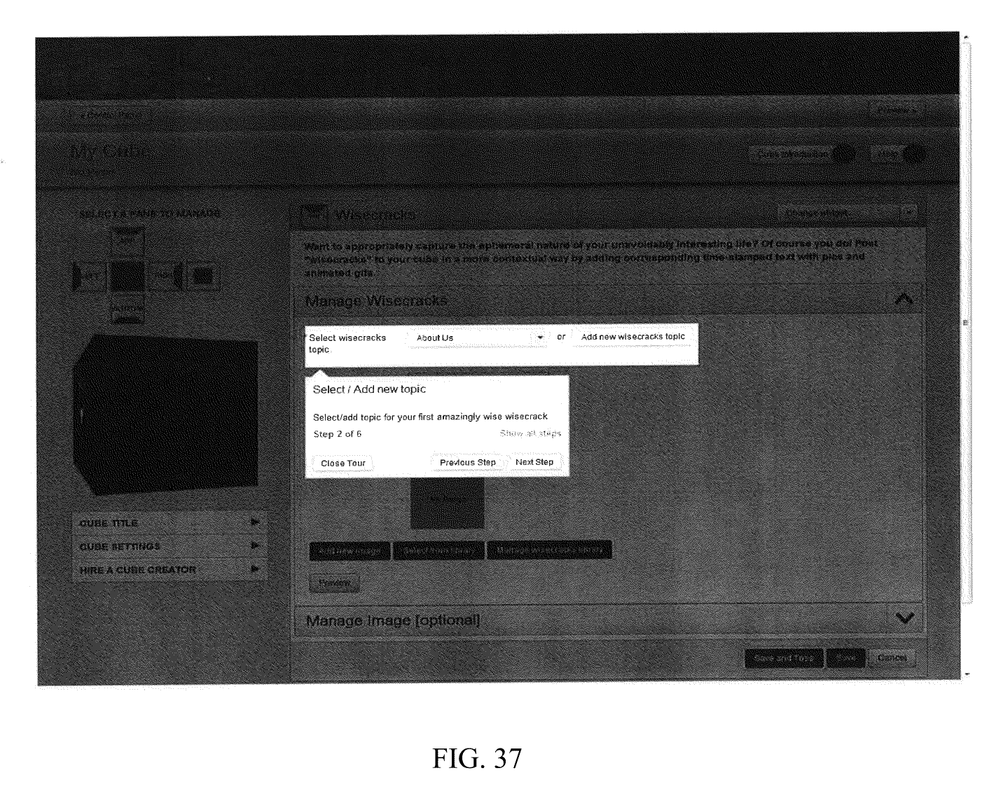

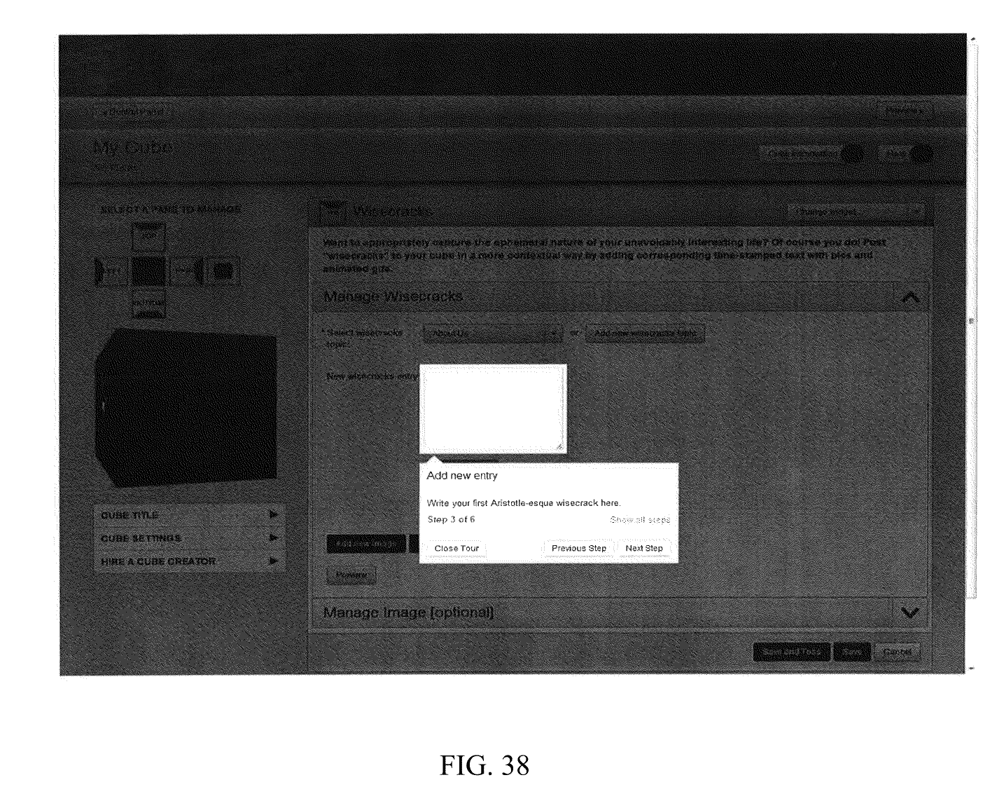

FIG. 36 is an exemplary illustration of the association of an additional content type with a created cube face. As is evident from FIG. 37, the content type illustrated in this example may be one or more blog entries or like postings. The topic for the blog entries may be entered by the user, as may be a new entry or a responsive entry as is further illustrated in FIG. 38.

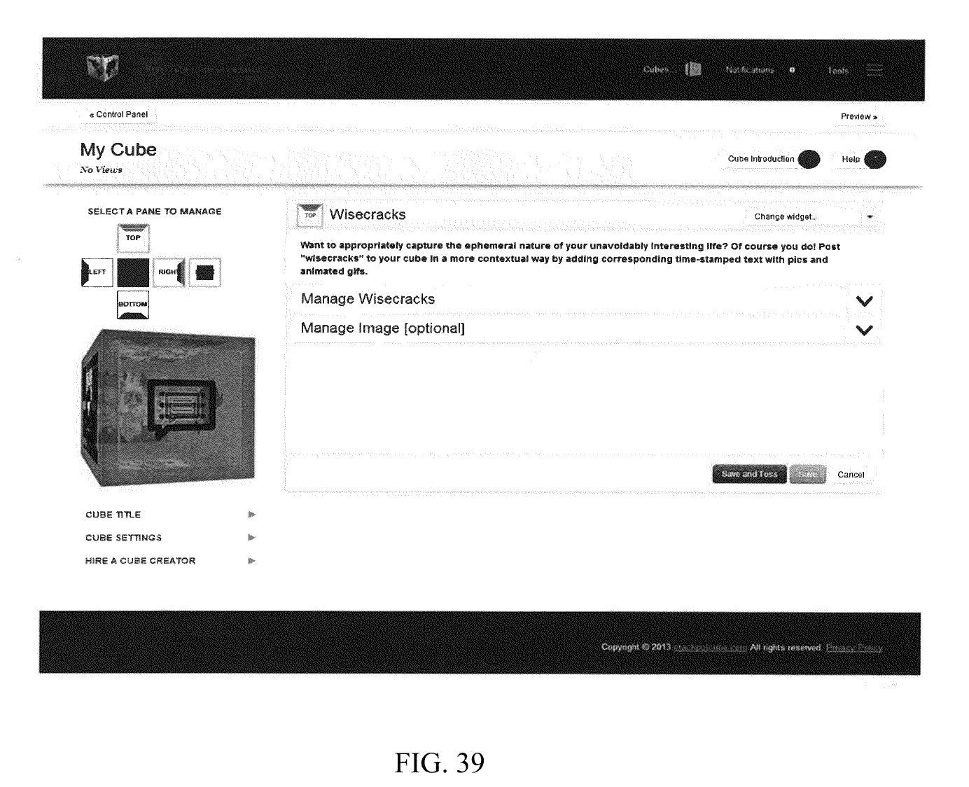

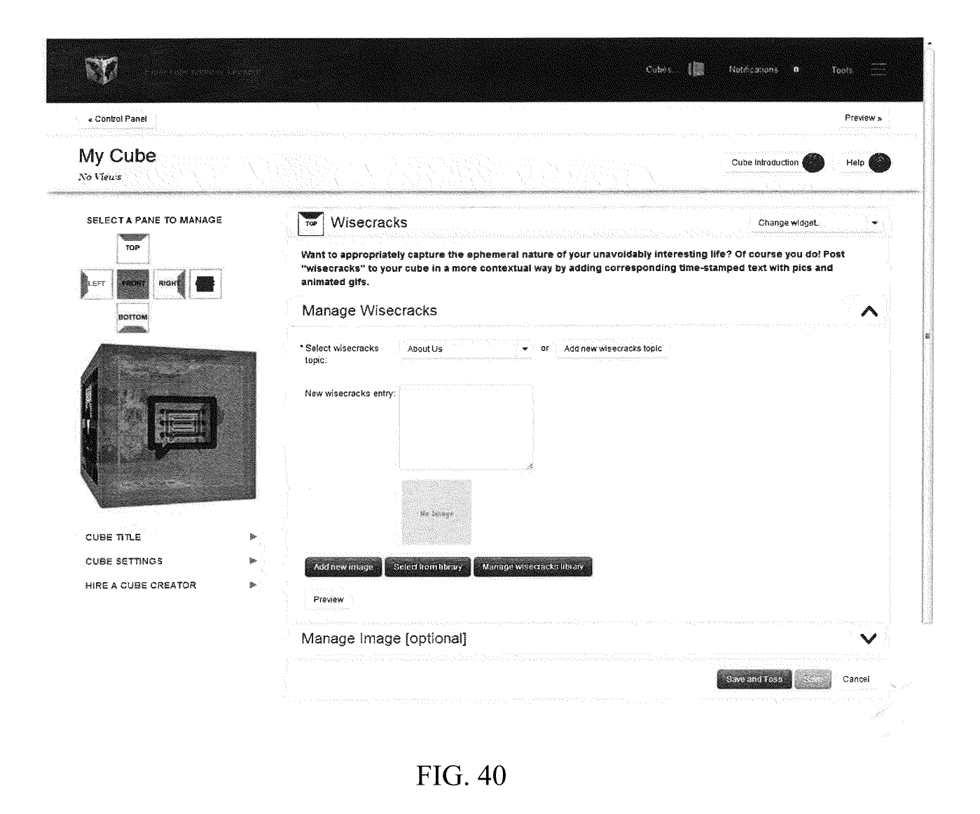

FIG. 39 illustrates the management of blog or like posts for association with one or more cube faces. FIG. 40 further illustrates that the management of posts may be by topic, or based on a new topic, and may allow for the user to associate an image and/or an icon on a cube face related to such a blog or like postings.

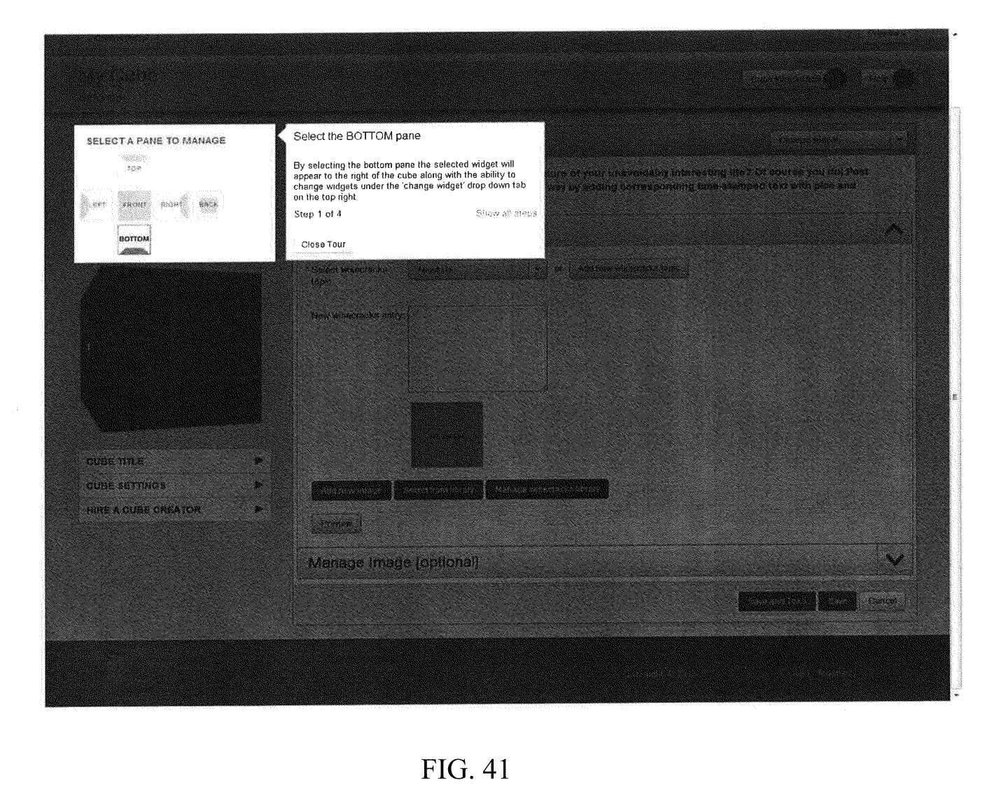

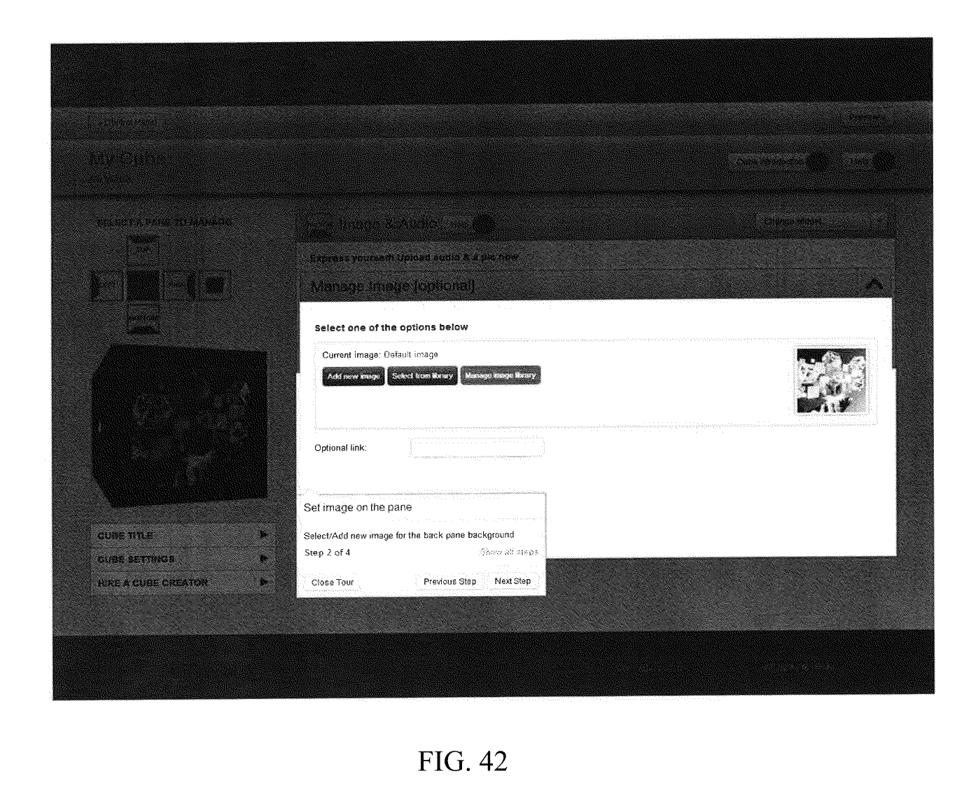

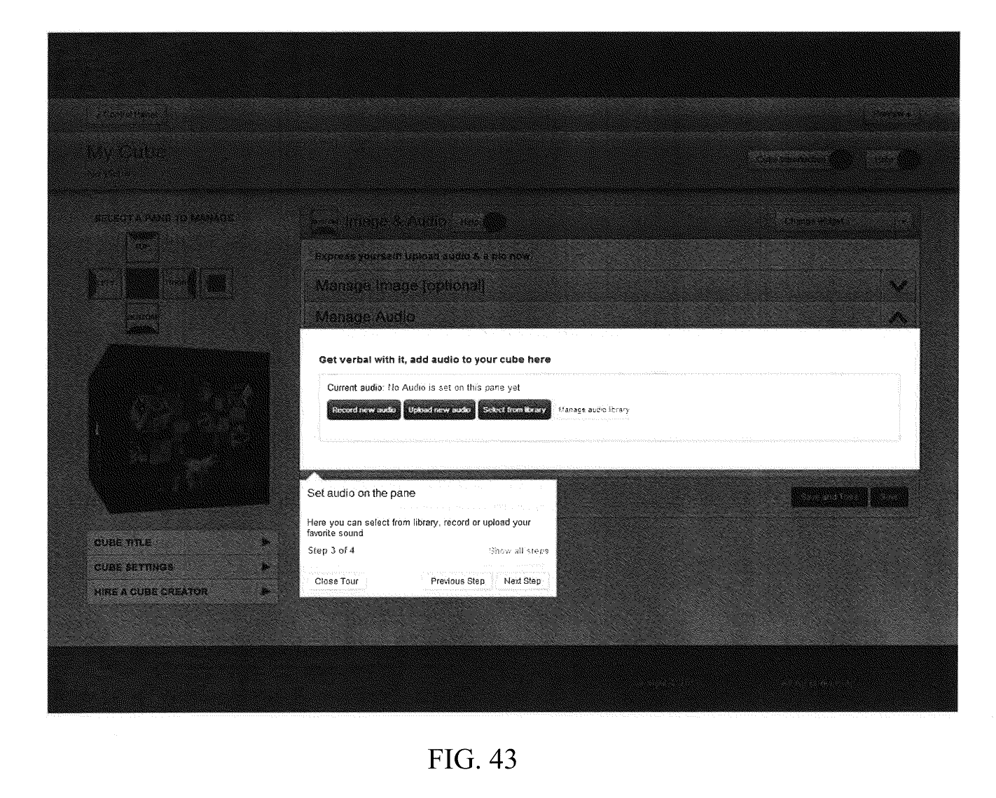

FIG. 41 illustrates the association of additional distinct content with a created cube face. As is evident in FIGS. 42 and 43, the content associated with a cube face in this example may be audio, and an associated image that is related to or indicative of the audio. As illustrated in the example of FIG. 43, audio for association with a cube face may be recorded anew, uploaded by the user, selected from a library of available audio (the content of which library may or may not be under the ownership or control of the user), or the like.

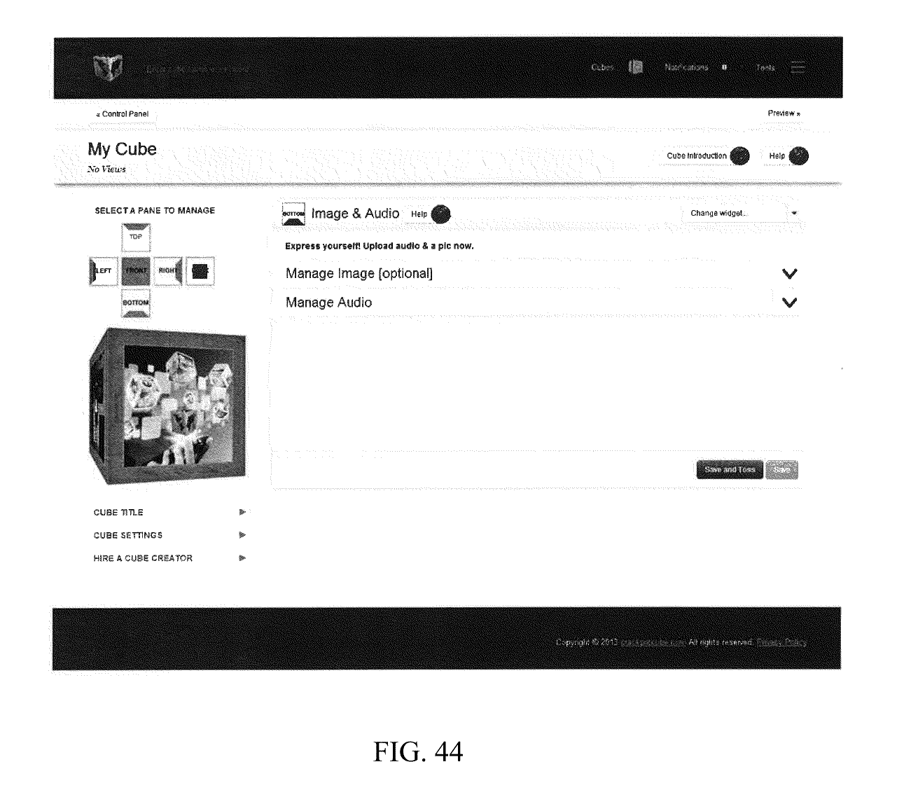

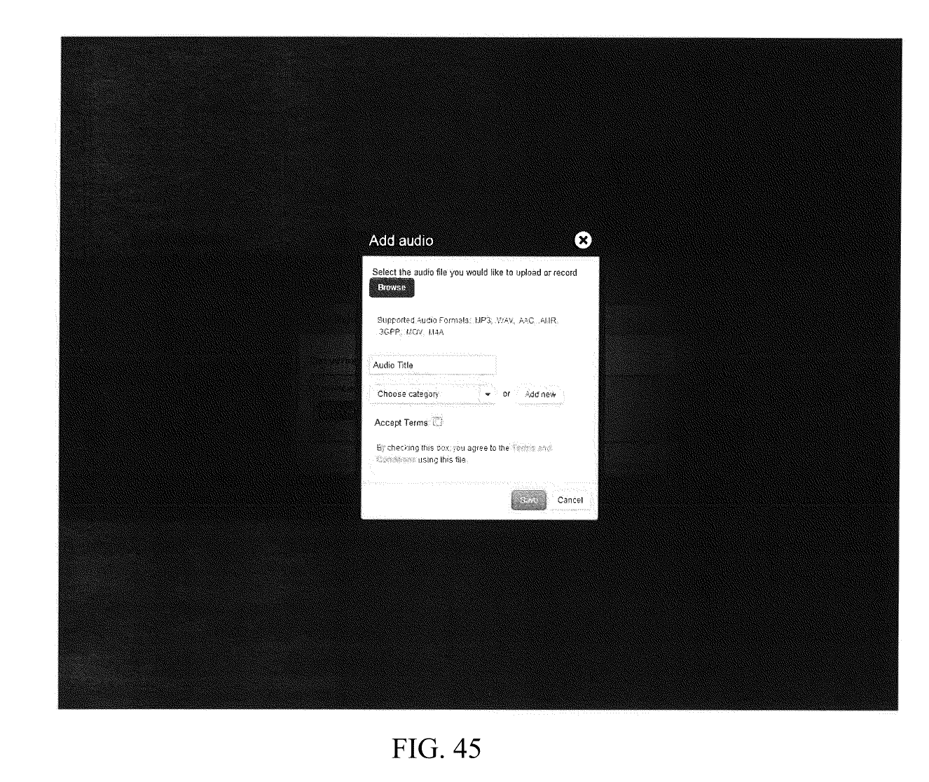

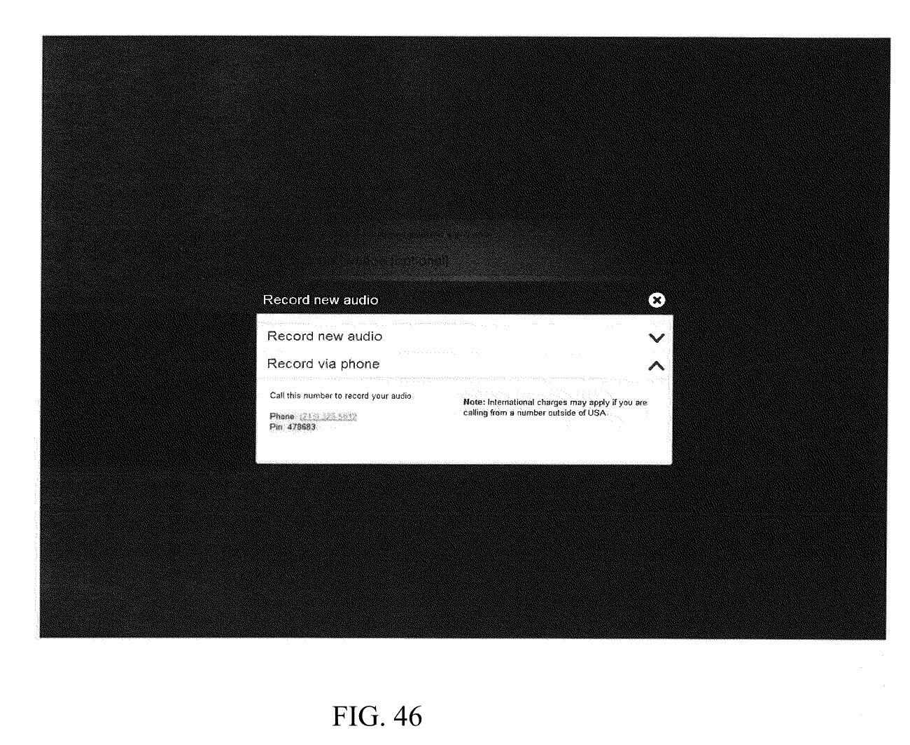

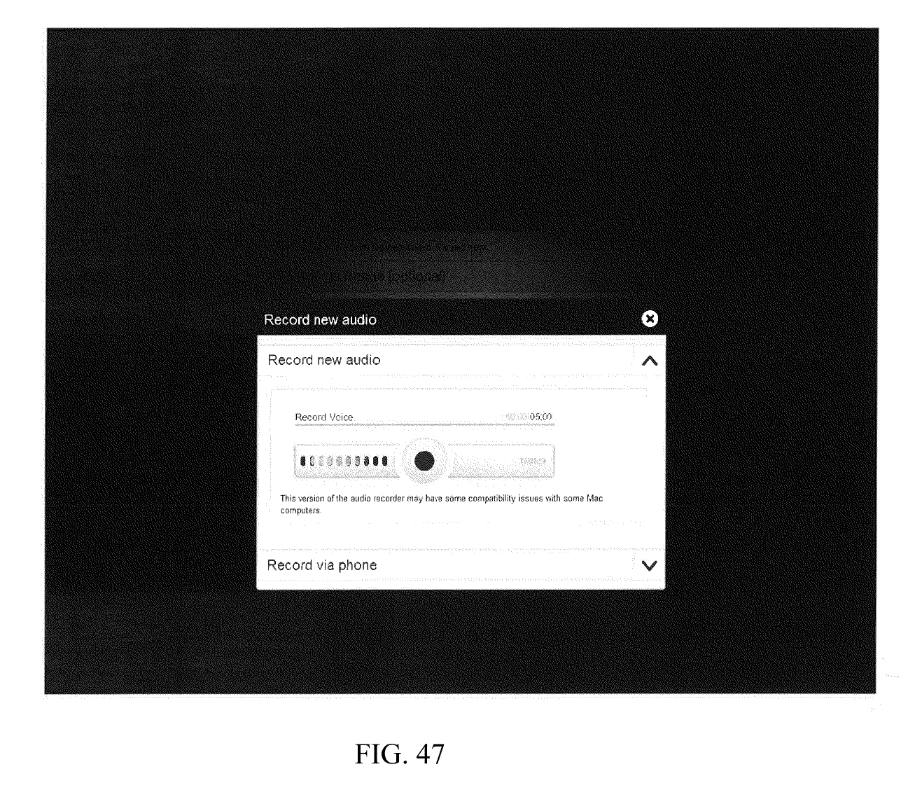

FIG. 44 illustrates the management of audio and associated images for creation of a new cube face. As is illustrated with greater particularity in the example of FIG. 45, the user may browse available audio, and/or may browse available audio libraries, for selection of the desired audio for association with a cube face. As illustrated in FIG. 46, to the extent the desired audio is not available in an existing library, the user may elect to generate new audio, such as for upload from the user's phone, or such as for use locally without upload. As will be understood from the example of FIG. 47, the user may be provided with graphical audio recording “equipment”, such as to allow for the user to control the upload, generation, or editing of new audio content.

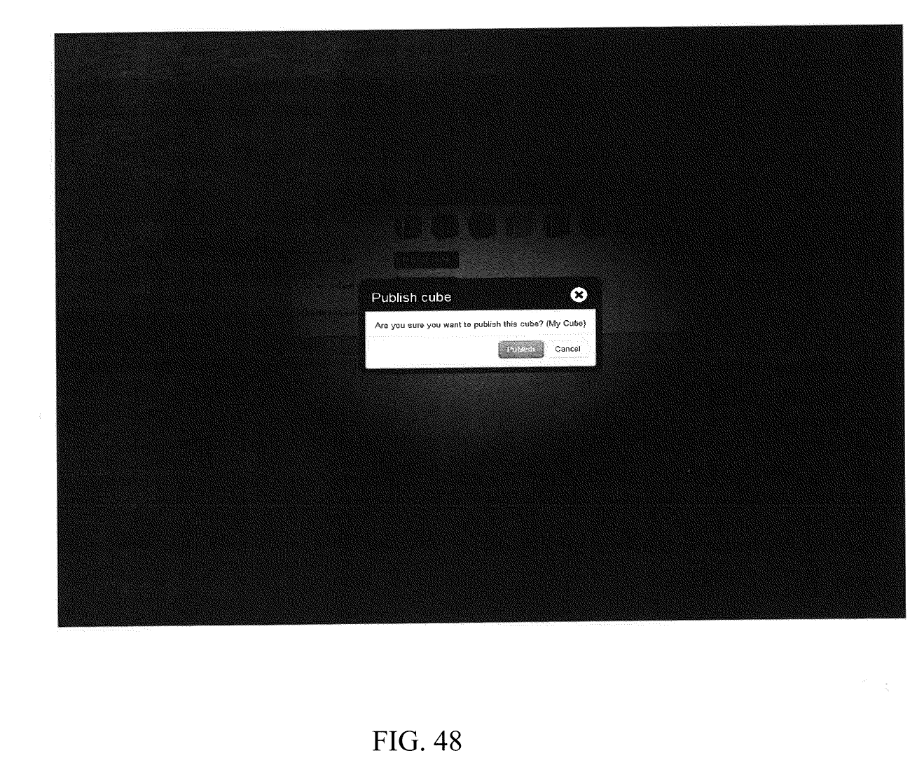

Finally, as discussed above and as illustrated in FIG. 48, upon completion of one, some, or all faces of a created cube, the user may be asked whether the user wishes to publish the cube. Should the user elect to publish the cube, the user may be provided with various publication options, such as those discussed above.

Those skilled in the art will appreciate, in light of the foregoing discussion, that cube creation may be even further simplified, such as by using pre-population of one or more cube faces. Such pre-population may be requested by the creating user, or offered by the GUI. The pre-population may include one face, or more than one face, of the cube, and the content corresponding thereto. Such pre-population may be based on frequency of use of content, frequency of request for content, frequency of viewing of content, ratio of “success” from viewing content (i.e., number of clicks or click-throughs), any available analytics (such as may be obtained, for example, as Google Analytics), or based on any other basis evident to those skilled in the art in light of the discussion herein.

Additionally, it will be appreciated that secondary indicators may be included within the same environment/location as a created cube. Such a secondary indicator may be resident on or proximate to the cube. By way of non-limiting example, a “moon” may be provided with a cube as a secondary indicator. The moon may provide secondary functionality, such as allowing for sharing of the cube, sending of a vcard, sharing of specific information, closing of the cube, chaining of the cube, etc.

By way of non-limiting example of the creation and publication of a cube pursuant to the foregoing disclosure, a user may publish information, such as images, to at least a portion of a cube, such as in a commercial transaction for goods, such as in a transaction for a car or another physical item. For example, if a user wishes to sell a vehicle, a cube may provide information about the car not otherwise available on traditional media platforms in which only a static view of pictures may be presented. The cube may contain within it a 3D image of the vehicle for sale, and may, on another face of the cube, provide corresponding 2D images. Additionally, one of the faces may comprise a link to content regarding reviews, ratings, and/or specifications of the vehicle. More specifically, using a transparent cube as described herein may allow for the user to provide a 3D image of a car for sale, and another at least one side of the cube having viewable information related to that vehicle and sale particulars, such as, for example, price, condition, make, model, location and service history.

As referenced throughout, cube creation may be performed pursuant to a plurality of design rules stored in at least one memory associated with at least one local and/or remote processor, and, in the course of cube creation, rules may be entered or selected governing ultimate uses of the cube. For example, a user may post information from a particular location to her cube, and/or may limit access to the information posted, such as limiting access to other authorized viewers of the cube within a certain radius of the same location, i.e., only prospective buyers of the afore-discussed vehicle within 50 miles of the location of the vehicle may view the car's “sale cube.”

By way of further example, a first user may be in a saloon with friends and may post to a cube pictures of the festivities which occurred during the time spent in the saloon. These images and/or the cube itself may be locationally locked by the first user so as to restrict access to the images and/or cube to those proximate to the saloon. Likewise, later access may be restricted only to those who were resident at the saloon for the night of the festivities, and who are befriended to the cube-creating user.

Moreover, with regard to the saloon cube as discussed herein, later viewers may have access to the images and/or cube limited to an authorization, such as might stem from presence at the saloon during the cube creation. Further, access to the images and/or cube may be gained by the authorized viewer only when that viewer is at least proximate to the saloon.

Limiting information in this way has many advantages over the current state of social networks. Importantly, such restrictions limit third party knowledge of the whereabouts of persons and may thus protect privacy—such as geographically or temporally—based on employing rules during cube creation. This may be useful in combating nefarious actors, such as those who may, for example, seek to take advantage of an absence from a place of residence and/or work, as evidenced on a typical social networking site. Similarly, the present invention may allow, for example, monitoring and/or limiting the content viewed by children, such as based on age or like access rules associated with each cube by the cube creator. For example, a cube may be specifically created for an educational purpose and distributed only to a certain age of child.

Thus, in an embodiment of the present invention, time may be used as a way to restrict access to posted content. For example, a first user may post content related to a past birthday, and may restrict access to that content temporally. Thus, for example, to avoid cluttering a social information feed, the user may apply at least one rule which limits the viewing of the past birthday content to the 5 days leading up to the date of the next birthday, or the next birthday party for that user or a friend of that user.

This type of functionality, namely the ability to restrict access to content based on location and/or time, facilitates masked restrictions which are not generally known and/or accessible to authorized viewers of the creating user. Masking restrictions limits the possible personal offense that a user may feel if she is knowingly being denied access to content. More importantly, those viewers, being unaware of the restriction, may be persons that the user would not want to put on notice of such restriction—for example, a boss or parent of the creating user. Having this control of when and/or where content is accessible may provide a confidence to the creating user to post more “embarrassing” content within the cube platform, rather than fearing the posting of such content in different forum. In this way, the present invention may prevent user attrition from the cube platform simply because various content may not be suitable for all otherwise authorized viewers. Indeed, when used in conjunction with existing social networking sites, the present invention may provide for increased use by that site's users, and may stem attrition away from the particular social network site based on, at least in part, the unwanted viewing of certain content by otherwise authorized viewers.

Although the herein disclosed systems and methods have been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the discussion herein and any claims appended hereto.

What is claimed is:

1. A computer-implemented platform for creating an element having three dimensions and capable of providing content of at least one of a plurality of types on a face in each of the dimensions, comprising:
a non-transitory computer readable storage medium having encoded thereon non-transitory computer executable instructions which, when executed by at least one processor:
provide, on at least one computing network, a graphical user interface (GUI) for the computer-implemented platform that:
provides access to a plurality of content comprising a plurality of content types;
allows for selection of content from the plurality of content for accessibility uniquely on each of the faces of the element;
provides at least two of a time, type and location stamp in association with the selected content for each face;
allows for selection of access rules for third parties attempting to access the selected content.

2. The platform of claim 1, wherein the provided GUI further allows for selection of an icon relevant to the content type of the selected content for display on each face.

3. The platform of claim 1, wherein the provided GUI further allows for selection of an image related to the selected content for display on each face.

4. The platform of claim 1, wherein the content comprises at least one of an image, a video, an audio, a blog post, a social network link, a feed, a widget, an app, and profile information.

5. The platform of claim 1, wherein the content type comprises one of image, video, audio, blog, interactive, static, social media, and profile.

6. The platform of claim 1, wherein the element comprises six faces.

7. The platform of claim 1, wherein the GUI is at least partially local on the at least one network, and wherein at least some of the plurality of content is remote on the at least one network.

8. The platform of claim 1, wherein the GUI is at least partially remote on the at least one network, and wherein at least some of the plurality of content is local on the at least one network.

9. The platform of claim 1, wherein the non-transitory computer readable storage medium comprises mobile device storage.

10. The platform of claim 9, wherein the providing of the GUI further comprises assessing compatibility of a mobile device including the mobile device storage.

11. The platform of claim 1, wherein the platform at least partially comprises an app.

12. The platform of claim 1, wherein the GUI further allows for selection of the face for the creating.

13. The platform of claim 1, wherein the element comprises a cube shape.

14. The platform of claim 1, wherein the element comprises a pyramidal shape.

15. The platform of claim 1, wherein the access rules comprise inclusive rules.

16. The platform of claim 1, wherein the access rules comprise inclusive rules.

17. The platform of claim 1, wherein the access rules comprise rules governing viewing of the faces.

18. The platform of claim 17, wherein the rules governing viewing comprise rules governing rotation through the faces.

19. The platform of claim 1, wherein the non-transitory computer readable storage medium comprises desktop computer storage.

20. The platform of claim 1, wherein the access rules govern access according to the provided at least two of the time, the type and the location stamp.
